(19) United States
(12) Patent Application Publication
(10) Pub. No.: US 2013/0055517 A1
(43) Pub. Date: Mar. 7, 2013

(54) ARTICLE AND SOIL CAPTURE AGENT FOR CLEANING SURFACES

(71) Applicants: Robin Lynn McKiernan, Mason, OH (US); Steven Daryl Smith, Fairfield, OH (US); Robert Joseph McChain, Cincinnati, OH (US); Charles William Neal, Fairfield, OH (US)

(72) Inventors: Robin Lynn McKiernan, Mason, OH (US); Steven Daryl Smith, Fairfield, OH (US); Robert Joseph McChain, Cincinnati, OH (US); Charles William Neal, Fairfield, OH (US)

(21) Appl. No.: 13/598,782

(22) Filed: Aug. 30, 2012

Related U.S. Application Data
(60) Provisional application No. 61/530,124, filed on Sep. 1, 2011.

(51) Int. Cl. D21H 13/26; B08B 1/00; C11D 17/00

(52) U.S. Cl. 15/104.93; 510/445; 162/146

(57) ABSTRACT

An article and soil capture agent for cleaning a surface.

### CROSS REFERENCE TO RELATED APPLICATIONS

This application claims the benefit of U.S. Provisional Application No. 61/530,124 filed Sep. 1, 2011.

### FIELD OF THE INVENTION

The present disclosure generally relates to an article and soil capture agent for cleaning surfaces.

### BACKGROUND OF THE INVENTION

In the past, cleansing articles, such as paper towels, have been commonly utilized in combination with liquid cleaning compositions to clean windows, mirrors, countertops, and other hard surfaces. Known cleansing articles typically provide cleaning performance primarily by absorption of soil laden fluid, consequently, the cleaning performance of known cleansing articles is limited by the ability of the cleansing articles to absorb and retain the soil laden fluid.

Improved removal of soil from various surfaces continues to be a big consumer need. Formulators have attempted to enhance the soil removal properties of known cleansing articles by incorporating soil capture agents into liquid cleaning compositions. There are known liquid cleaning compositions, such as liquid spray cleaners, that comprise a soil capture agent, for example a Mirapol® polymer (a copolymer of an acrylic acid and a diquaternary ammonium compound) available from Rhodia and/or a polyacrylamide polymer, such as a Hyperfloc® polymer available from Hychem Inc. and/or a Lupasol® polymer (a polyethyleneimine) available from BASF Corporation, that are designed to aid in the removal of soil from various surfaces when applied to the surface in a liquid form.

One problem faced by formulators is that consumers desire improved soil adsorption properties from cleansing articles compared to such properties from known cleansing articles.

However, there still exists a need for a cleansing article and soil capture agent that exhibit enhanced soil adsorption properties compared to known materials.

### SUMMARY OF THE INVENTION

In accordance with one embodiment, an article comprises a soil capture agent. The soil capture agent comprises a polymer. The polymer comprises two or more monomeric units selected from the group consisting of nonionic monomeric units, anionic monomeric units, cationic monomeric units and zwitterionic monomeric units. The polymer comprises at least one monomeric unit selected from group a and at least one monomeric unit selected from groups b, c and d. At least a portion of the article exhibits a Soil Adsorption Value of at least 75 mg as measured according to a Soil Adsorption Test Method described herein.

One solution to the problem identified above is to provide cleaning systems and/or cleansing articles that comprise a soil capture agent that improves the soil adsorption properties of the cleaning system and/or cleansing articles compared to known cleaning systems and/or cleansing articles.

In accordance with another embodiment, a cleaning system comprises at least a portion of an article and a soil capture agent. The soil capture agent comprises a polymer. The polymer comprises three or more monomeric units selected from the group consisting of nonionic monomeric units, anionic monomeric units, cationic monomeric units and zwitterionic monomeric units. The polymer comprises at least one monomeric unit selected from group a and at least two monomeric units selected from groups b, c and d. The at least two monomeric units are present in the polymer at a molar ratio of from about 3:1 to about 1:3.

In accordance with yet another embodiment, a cleaning system comprises at least a portion of an article and a soil capture agent. The soil capture agent comprises a polymer. The polymer comprises two or more monomeric units selected from the group consisting of nonionic monomeric units, anionic monomeric units, cationic monomeric units and zwitterionic monomeric units. The polymer comprises at least one monomeric unit selected from group a and at least one monomeric unit selected from groups b, c and d. The polymer comprises a number average molecular weight from about 500,000 g/mol to about 2,000,000 g/mol and/or from about 1,000,000 to about 1,500,000 g/mol.

In accordance with still another embodiment, an article for cleaning a surface comprises a soil capture agent. The soil capture agent comprises a polymer. The polymer comprising two or more monomeric units selected from the group consisting of nonionic monomeric units, anionic monomeric units, cationic monomeric units, zwitterionic monomeric units, and mixtures thereof. The polymer exhibits a Soil Adsorption Value of about 40 mg or more as measured according to the Soil Adsorption Test Method described herein.

While the specification concludes with claims particularly pointing out and distinctly claiming the subject matter that is regarded as the present invention, it is believed that the invention will be more fully understood from the following description.

### DETAILED DESCRIPTION OF THE INVENTION

### I. Definitions

As used herein, the following terms shall have the meaning specified thereafter:

“Anionic monomer” as used herein means a monomer that exhibits a net negative charge at a pH of 7 and/or is identified as an anionic monomer herein. An anionic monomer is generally associated with one or more cations such as protons or cations of alkali metal or alkaline earth metal, for example sodium of cationic groups such as ammonium.

“Anionic monomeric unit” as used herein means a monomeric unit that exhibits a net negative charge at a pH of 7 and/or is identified as an anionic monomeric unit herein. An anionic monomeric unit may be derived from an anionic monomer. An anionic monomeric unit is generally associated with one or more cations such as protons or cations of alkali metal or alkaline earth metal, for example sodium of cationic groups such as ammonium.

“Article” as used herein means is any solid matter, such as a web, sponge, foam structure, co-form material, or particle. In one example, the article is a dry article. In one example, at least a portion of the article exhibits a basis weight of about 150 gsm or less and/or about 100 gsm or less and/or from about 30 gsm to about 95 gsm. In one example, the article comprises a material formed of cotton such that at least a portion of the article comprises excess anionic charge.

“Basis Weight” as used herein is the weight per unit area of a sample reported in gsm and is measured according to the Basis Weight Test Method described herein.

“Cationic monomer” as used herein means a monomer that exhibits a net positive charge at a pH of 7 and/or is identified as a cationic monomer herein. A cationic monomer is generally associated with one or more anions such as a chloride ion, a bromide ion, a sulfonate group and/or a methyl sulfate group.

“Cationic monomeric unit” as used herein means a monomeric unit that exhibits a net positive charge at a pH of 7 and/or is identified as a cationic monomeric unit herein. A cationic monomeric unit is generally associated with one or more anions such as a chloride ion, a bromide ion, a sulfonate group and/or a methyl sulfate group.

“Cleaning systems” refer to an article and a soil capture agent. Such cleaning systems can include Swiffer-brand products and pads.

“Dry article” as used herein means that the article includes less than about 30% and/or, less than about 20% and/or less than 10% and/or less than 5% and/or less than 3% and/or less than 2% and/or less than 1% and/or less than 0.5% by weight of moisture as measured according to the Moisture Content Test Method described herein.

“Fiber” and/or “Filament” as used herein means an elongate particulate having an apparent length greatly exceeding its apparent width, i.e. a length to diameter ratio of at least about 10. In one example, a “fiber” is an elongate particulate that exhibits a length of less than 5.08 cm (2 in.) and a “filament” is an elongate particulate that exhibits a length of greater than or equal to 5.08 cm (2 in.).

“Fibrous structure” as used herein means a structure that comprises one or more fibrous filaments and/or fibers. In one example, a fibrous structure according to the present invention means an orderly arrangement of filaments and/or fibers within a structure in order to perform a function. Non-limiting examples of fibrous structures can include paper, fabrics (including woven, knitted, and non-woven), and absorbent pads (for example for diapers or feminine hygiene products).

“Film” refers to a sheet-like material wherein the length and width of the material far exceed the thickness of the material.

“Hard surface” refers to any kind of surfaces typically found in and around houses like bathrooms, kitchens, basements and garages, e.g., floors, walls, tiles, windows, countertops, sinks, showers, shower plastified curtains, wash basins, WCs, dishes, fixtures and fittings and the like made of different materials like ceramic, enamel, painted and un-painted concrete, plaster, bricks, vinyl, no-wax vinyl, linoleum, melamine, Formica®, glass, any plastics, metals, chromed surface and the like. The term surfaces as used herein also include household appliances including, but not limited to, washing machines, automatic dryers, refrigerators, freezers, ovens, microwave ovens, dishwashers and so on.

“Hydrophilic” and “Hydrophobic” As used herein, the term “hydrophilic” is used to refer to surfaces that are wettable by aqueous fluids deposited thereon. Hydrophilicity and wettability are typically defined in terms of contact angle and the surface tension of the fluids and surfaces involved. This is discussed in detail in the American Chemical Society publication entitled Contact Angle, Wettability and Adhesion, edited by Robert F. Gould (Copyright 1964) which is hereby incorporated by reference. A surface is said to be wetted by an aqueous fluid (hydrophilic) when the fluid tends to spread spontaneously across the surface. Conversely, a surface is considered to be “hydrophobic” if the aqueous fluid does not tend to spread spontaneously across the surface.

“Monomeric unit” as used herein is a constituent unit (sometimes referred to as a structural unit) of a polymer.

“Nonionic monomer” as used herein means a monomer that exhibits no net charge at a pH of 7 and/or is identified as a nonionic monomer herein.

“Nonionic monomeric unit” as used herein means a monomeric unit that exhibits no net charge at a pH of 7 and/or is identified as a nonionic monomeric unit herein. A nonionic monomeric unit may be derived from nonionic monomer.

“Number average molecular weight” as used herein means the number average molecular weight Mₙ as determined using gel permeation chromatography according to the protocol found in Colloids and Surfaces A. Physico Chemical & Engineering Aspects, Vol. 162, 2000, pg. 107-121.

“Paper product” refers to any formed fibrous structure product, which may, but not necessarily, comprise cellulose fibers. In one embodiment, the paper products of the present disclosure include tissue-towel paper products.

“Polydispersity Index” or “PDI” as used herein means the ratio of the weight average molecular weight to the number average molecular weight, M_{w}/Mₙ, as determined using gel permeation chromatography.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels), and folded sanitary tissue products such as napkins and/or facial tissues including folded sanitary tissue products dispensed from a container, such as a box. The sanitary tissue product may be convolutedly wound upon itself about a core or without a core to form a sanitary tissue product roll.

“Soil” refers to organic or inorganic material, often particulate in nature that may include dirt, clays, food particulates, sebum or greasy residue, soot, etc.

“Tissue-towel paper product” as used herein refers to products comprising paper tissue or paper towel technology in general, including, but not limited to, conventional felt-pressed or conventional wet-pressed tissue paper, pattern densified tissue paper, starch substrates, and high bulk, uncompacted tissue paper. Non-limiting examples of tissue-towel paper products include toweling, facial tissue, bath tissue, table napkins, and the like.

“Web” as used herein means a fibrous structure or a film.

“Weight average molecular weight” as used herein means the weight average molecular weight M_{w} as determined using gel permeation chromatography according to the protocol found in Colloids and Surfaces A. Physico Chemical & Engineering Aspects, Vol. 162, 2000, pg. 107-121.

“Zwitterionic monomer” as used herein means a monomer that exhibits both a negative charge and a positive charge on the same monomer at a pH of 7 and/or is identified as a zwitterionic monomer herein. A zwitterionic monomer is generally associated with one or more cations such as protons or cations of alkali metal or alkaline earth metal, for example sodium or cationic groups such as ammonium and one or more anions such as a chloride ion, a bromide ion, a sulfonate group and/or a methyl sulfate group.

“Zwitterionic monomeric unit” as used herein means a monomeric unit that exhibits both a negative charge and a positive charge on the same monomeric unit at a pH of 7 and/or is identified as a zwitterionic monomeric unit herein. A zwitterionic monomeric unit may be derived from a zwitterionic monomer. A zwitterionic monomeric unit is generally associated with one or more cations such as protons or cations of alkali metal or alkaline earth metal, for example sodium or cationic groups such as ammonium and one or more anions such as a chloride ion, a bromide ion, a sulfonate group and/or a methyl sulfate group.

### II. Polymers and Soil Capture Agents

A soil capture agent as described herein provides enhanced benefits in capturing soil. Such soil capture agents can be used singularly or in combination with other components to form a cleansing solution. In certain embodiments, such soil capture agents can include polymers. Such polymers can include several monomeric units thus it can be referred to as a copolymer rather than a homopolymer, which consists of a single type of monomeric unit. The polymers of the present disclosure may be a terpolymer (3 different monomeric units). The polymers of the present disclosure may be a random copolymer. In one example, a polymer of the present disclosure may be water-soluble and/or water-dispersible, which means that the polymer does not, over at least a certain pH and concentration range, form a two-phase composition in water at 23° C.±2.2° C. and a relative humidity of 50%±10%.

In one example, the polymers of the present invention exhibit a Number Average Molecular Weight of less than 2,000,000 g/mol and/or less than 1,750,000 g/mol and/or less than 1,700,000 g/mol and/or less than 1,500,000 g/mol and/or greater than 500,000 g/mol and/or greater than 900,000 g/mol. In another example, the polymers exhibit a Number Average Molecular Weight of from about 500,000 to 2,000,000 g/mol and/or from about 900,000 to 1,700,000 g/mol.

In another example, the polymers of the present invention exhibit a Soil Adsorption Value of at least 38 mg and/or at least 40 mg and/or at least 42 mg and/or at least 45 mg and/or at least 47 mg and/or at least 50 mg and/or at least 53 mg and/or at least 55 mg and/or at least 57 mg and/or at least 60 mg and/or at least 62 mg as measured according to the Soil Adsorption Test Method described herein.

In yet another example, the polymers of the present invention exhibit an excess charge (charge density at pH 4.5) of from about −0.1 meq/g and/or from about −0.05 meq/g and/or from about −0.02 meq/g and/or from about 0 meq/g and/or to about +0.1 meq/g and/or to about +0.09 meq/g and/or to about +0.08 meq/g and/or to about +0.06 meq/g and/or to about +0.05 meq/g and/or to about +0.02 meq/g as measured according to the Charge Density Test Method described herein. In still another example, the polymers of the present invention exhibit a charge density of from about −0.1 meq/g to about +0.1 meq/g and/or from −0.05 meq/g to about +0.1 meq/g and/or from about 0 to less than +0.1 meq/g and/or to less than +0.09 meq/g and/or to less than +0.08 meq/g and/or to less than +0.06 meq/g and/or to less than +0.05 meq/g as measured according to the Charge Density Test Method described herein. In one example, the polymers of the present invention exhibit an excess charge (charge density) of from about 0 to about 0.1 meq/g. In another example, the polymers of the present invention exhibit an excess charge (charge density) of about 0.05 meq/g or less.

In another example, the polymers exhibit a Polydispersity Index of less than 2.5 and/or of less than 2.0 and/or less than 1.7 and/or less than 1.5 and/or less than 1.3.

In one example, a polymer of the present invention comprises two or more monomeric units selected from the group consisting of: a. nonionic monomeric units; b. anionic monomeric units; c. cationic monomeric units; d. zwitterionic monomeric units; and e. mixtures thereof.

The polymers of the present invention may exhibit a Soil Adsorption Value of at least 38 mg as measured according to the Soil Adsorption Test Method described herein.

In one example, the polymers of the present invention are water-soluble.

a. Nonionic Monomeric Units

The nonionic monomeric units may be selected from the group consisting of: nonionic hydrophilic monomeric units, nonionic hydrophobic monomeric units, and mixtures thereof.

Non-limiting examples of nonionic hydrophilic monomeric units suitable for the present invention include nonionic hydrophilic monomeric units derived from nonionic hydrophilic monomers selected from the group consisting of: hydroxyalkyl esters of α,β-ethylenically unsaturated acids, such as hydroxyethyl or hydroxypropyl acrylates and methacrylates, glyceryl monomethacrylate, α,β-ethylenically unsaturated amides such as acrylamide, N,N-dimethylmethacrylamide, N-methylolacrylamide, α,β-ethylenically unsaturated monomers bearing a water-soluble polyoxyalkylene segment of the poly(ethylene oxide) type, such as poly(ethylene oxide) α-methacrylates (Bisomer S20W, S10W, etc., from Laporte) or am-dimethacrylates, Sipomer BEM from Rhodia (ω-behenyl polyoxyethylene methacrylate), Sipomer SEM-25 from Rhodia (ω-tristyrylphenyl polyoxyethylene methacrylate), α,β-ethylenically unsaturated monomers which are precursors of hydrophilic units or segments, such as vinyl acetate, which, once polymerized, can be hydrolyzed in order to give rise to vinyl alcohol units or polyvinyl alcohol segments, vinylpyrrolidones, α,β-ethylenically unsaturated monomers of the ureido type, and in particular 2-imidazolidinone-ethyl methacrylamide (Sipomer WAM II from Rhodia), and mixtures thereof. In one example, the nonionic hydrophilic monomeric unit is derived from acrylamide.

Non-limiting examples of nonionic hydrophobic monomeric units suitable for the present invention include nonionic hydrophobic monomeric units derived from nonionic hydrophobic monomers selected from the group consisting of: vinylaromatic monomers such as styrene, alpha-methylstyrene, vinyltoluene, vinyl halides or vinylidene halides, such as vinyl chloride, vinylidene chloride, C₁-C₁₂ alkylesters of α,β-monoethylenically unsaturated acids such as methyl, ethyl or butyl acrylates and methacrylates, 2-ethylhexyl acrylate, vinyl esters or allyl esters of saturated carboxylic acids, such as vinyl or allyl acetates, propionates, versatates, stearates, α,β-monoethylenically unsaturated nitriles containing from 3 to 12 carbon atoms, such as acrylonitrile, methacrylonitrile, α-olefins such as ethylene, conjugated dienes, such as butadiene, isoprene, chloroprene, and mixtures thereof.

b. Anionic Monomeric Units

Non-limiting examples of anionic monomeric units suitable for the present invention include anionic monomeric units derived from anionic monomers selected from the group consisting of: monomers having at least one carboxylic function, for instance α,β-ethylenically unsaturated carboxylic acids or the corresponding anhydrides, such as acrylic, methacrylic or maleic acids or anhydrides, fumaric acid, itaconic acid, N-methacroylalanine, N-acryloylglycine, and their water-soluble salts, monomers that are precursors of carboxylate functions, such as tert-butyl acrylate, which, after polymerization, give rise to carboxylic functions by hydrolysis, monomers having at least one sulfate or sulfonate function, such as 2-sulfooxyethyl methacrylate, vinylbenzene sulfonic acid, allyl sulfonic acid, 2-acrylamido-2-methylpropane sulfonic acid (AMPS), sulfoethyl acrylate or methacrylate, sulfopropyl acrylate or methacrylate, and their water-soluble salts, monomers having at least one phosphonate or phosphate function, such as vinylphosphonic acid, etc., the esters of ethylenically unsaturated phosphates, such as the phosphates derived from hydroxyethyl methacrylate (Empicryl 6835 from Rhodia) and those derived from polyoxyalkylene methacrylates, and their water-soluble salts, and 2-carboxyethyl acrylate (CEA), and mixtures thereof. In one example, the anionic monomeric unit is derived from an anionic monomer selected from the group consisting of: acrylic acid, AMPS, CEA, and mixtures thereof. In another example, the anionic monomeric unit is derived from acrylic acid.

c. Cationic Monomeric Units

Non-limiting examples of cationic monomeric units suitable for the present invention include cationic monomeric units derived from cationic monomers selected from the group consisting of: N,N-(dialkylamino-ω-alkyl)amides of α,β-monoethylenically unsaturated carboxylic acids, such as N,N-dimethylaminomethylacrylamide or -methacrylamide, 2-(N,N-dimethylamino)ethylacrylamide or -methacrylamide, 3-(N,N-dimethylamino)propylacrylamide or -methacrylamide, and 4-(N,N-dimethylamino)butylacrylamide or -methacrylamide, α,β-monoethylenically unsaturated amino esters such as 2-(dimethylamino)ethyl acrylate (DMAA), 2-(dimethylamino)ethyl methacrylate (DMAM), 3-(dimethylamino)propyl methacrylate, 2-(tert-butylamino)ethyl methacrylate, 2-(dipentylamino)ethyl methacrylate, and 2(diethylamino)ethyl methacrylate, vinylpyridines, vinylamine, vinylimidazolines, monomers that are precursors of amine functions such as N-vinylformamide, N-vinylacetamide, which give rise to primary amine functions by simple acid or base hydrolysis, acryloyl- or acryloyloxyammonium monomers such as trimethylammonium propyl methacrylate chloride, trimethylammonium ethylacrylamide or -methacrylamide chloride or bromide, trimethylammonium butylacrylamide or -methacrylamide methyl sulfate, trimethylammonium propylmethacrylamide methyl sulfate, (3-methacrylamidopropyl)trimethylammonium chloride (MAPTAC), (3-methacrylamidopropyl)trimethylammonium methyl sulphate (MAPTA-MES), (3-acrylamidopropyl)trimethylammonium chloride (APTAC), methacryloyloxyethyl-trimethylammonium chloride or methyl sulfate, and acryloyloxyethyltrimethylammonium chloride; 1-ethyl-2-vinylpyridinium or 1-ethyl-4-vinylpyridinium bromide, chloride or methyl sulfate; N,N-dialkyldiallylamine monomers such as N,N-dimethyldiallylammonium chloride (DADMAC); polyquaternary monomers such as dimethylaminopropylmethacrylamide chloride and N-(3-chloro-2-hydroxypropyl)trimethyl ammonium (DIQUAT or DQ) and 2-hydroxy-N¹-(3-(2((3-methacrylamidopropyl)dimethylammino)-acetamido)propyl)-N¹,N¹,N³,N³,N³-pentamethylpropane-1,3-diaminium chloride (TRIQUAT or TQ), and mixtures thereof. In one example, the cationic monomeric unit comprises a quaternary ammonium monomeric unit, for example a monoquaternary ammonium monomeric unit, a diquaternary ammonium monomeric unit and a triquaternary monomeric unit. In one example, the cationic monomeric unit is derived from MAPTAC. In another example, the cationic monomeric unit is derived from DADMAC. In still another example, the cationic monomeric unit is derived from TQ.

In one example, the cationic monomeric units are derived from cationic monomers selected from the group consisting of: dimethylaminoethyl (meth)acrylate, dimethylaminopropyl (meth)acrylate, di-tert-butylaminoethyl (meth)acrylate, dimethylaminomethyl (meth)acrylamide, dimethylaminopropyl (meth)acrylamide, ethylenimine, vinylamine, 2-vinylpyridine, 4-vinylpyridine and vinyl imidazole, and mixtures thereof.

In another example, the cationic monomeric units are derived from cationic monomers selected from the group consisting of: trimethylammonium ethyl (meth)acrylate bromide, chloride or methyl sulfate, trimethylammonium ethyl (meth)acrylate bromide, chloride or methyl sulfate, trimethylammonium ethyl (meth)acrylate bromide, chloride or methyl sulfate, dimethylaminoethyl (meth)acrylate benzyl chloride, 4-benzoylbenzyl dimethylammoniumethyl (meth)acrylate bromide, chloride or methyl sulfate, trimethylammonium ethyl (meth)acrylamido bromide, chloride, or methyl sulfate, trimethylammonium propyl (meth)acrylamido braomide, chloride, or methyl sulfate, vinyl benzyl trimethyl ammonium bromide, chloride or methyl sulfate, diallyldimethyl ammonium chloride, 1-ethyl-2-vinylpyridinium bromide, chloride or methyl sulfate, 4-vinylpyridinium bromide, chloride or methyl sulfate, and mixtures thereof.

d. Zwitterionic Monomeric Units

Non-limiting examples of zwitterionic monomeric units suitable for the present invention include zwitterionic monomeric units derived from zwitterionic monomers selected from the group consisting of: sulfobetaine monomers, such as sulfopropyl dimethylammonium ethyl methacrylate (SPE from Raschig), sulfopropyldimethylammonium propylmethacrylamide (SPP from Raschig), and sulfopropyl-2-vinylpyridinium (SPV from Raschig), 3-((3-methacrylamidopropyl)dimethylammonio)propane-1-sulfonate (SZ), phosphobetaine monomers, such as phosphatoethyl trimethylammonium ethyl methacrylate, carboxybetaine monomers, N-(carboxymethyl)-3-methacrylamido-N,N-dimethlpropan-1-aminium chloride (CZ). In one example, the zwitterionic monomeric unit is derived from CZ, SZ, and mixtures thereof.

In one example, a polymer of the present invention may comprise at least one monomeric unit selected from groups a (nonionic monomeric units) and b (anionic monomeric units) and at least one monomeric unit selected from groups c (cationic monomeric units) and d (zwitterionic monomeric units).

In one example, the polymer comprises at least 69.9% wt and/or at least 70% wt and/or at least 75% wt and/or at least 80% wt and/or at least 85% wt and/or at least 90% wt and/or at least 95% wt and/or at least 98% wt and/or at least 99% wt and/or at least 99.5% wt of a monomeric unit from group a. The balance of the polymer (no more than 30.1% wt and/or no more than 30% wt and/or no more than 25% wt and/or no more than 20% wt and/or no more than 15% wt and/or no more than 10% wt and/or no more than 5% wt and/or no more than 2% wt and/or no more than 1% wt and/or no more than 0.5% wt total) comprises one or more monomeric units selected from groups b, c, and d. In one example, the polymer comprises from about 70% to about 99.5% wt of a monomeric unit from group a, from about 0.1% to about 10% wt of a monomeric unit from group b, and from about 0.3% to about 29% wt of a monomeric unit from group c. In still another example, the polymer comprises from about 70% to about 99.5% wt of a monomeric unit from group a, from about 0.5% to about 30% wt combined of monomeric units from groups b and c.

In one example, the polymer comprises from about 70% to about 99.5% wt of a monomeric unit from group a, from about 0.1% to about 10% wt of a monomeric unit from group b, and from about 0.3% to about 29% wt of a monomeric unit from group d. In still another example, the polymer comprises from about 70% to about 99.5% wt of a monomeric unit from group a, from about 0.5% to about 30% wt combined of monomeric units from groups b and d.

In one example, the polymer comprises from about 70% to about 99.5% wt of a monomeric unit from group a, and the balance to 100% comprising from about 0.2% to about 29% wt of a monomeric unit from group c, and from about 0.3% to about 29% wt of a monomeric unit from group d. In still another example, the polymer comprises from about 70% to about 99.5% wt of a monomeric unit from group a, from about 0.5% to about 30% wt combined of monomeric units from groups c and d.

In one example, the polymer comprises at least 0.1% wt and/or at least 1% and/or at least 5% wt and/or at least 7% wt and/or at least 10% wt and/or to about 25% wt and/or to about 20% wt and/or to about 15% wt of a monomeric unit from group b.

In one example, polymer comprises at least 0.1% wt and/or at least 0.3% wt and/or at least 1% and/or at least 5% wt and/or at least 7% wt and/or at least 10% wt and/or to about 75% wt and/or to about 70% wt and/or to about 65% wt and/or to about 55% wt and/or to about 40% wt and/or to about 30% wt and/or to about 25% wt and/or to about 20% wt and/or to about 15% wt of a monomeric unit from group c.

In one example, polymer comprises at least 0.1% wt and/or at least 0.3% wt and/or at least 0.5% and/or at least 1% and/or at least 5% wt and/or at least 7% wt and/or at least 10% wt and/or to about 75% wt and/or to about 70% wt and/or to about 65% wt and/or to about 55% wt and/or to about 40% wt and/or to about 30% wt and/or to about 25% wt and/or to about 20% wt and/or to about 15% wt of a monomeric unit from group d.

In another example, the polymer comprises no more than 30.1% wt of a monomeric unit selected from the group consisting of: group b, group c, group d, and mixtures thereof.

In one example, the polymer may comprise a monomeric unit from group a and a monomeric unit from group b.

In one example, the polymer may comprise a monomeric unit from group a and a monomeric unit from group c.

In another example, the polymer of the present invention may comprise a monomeric unit from group a and a monomeric unit from group d.

In still another example, the polymer of the present invention may comprise a monomeric unit from group b and a monomeric unit from group c.

In still another example, the polymer of the present invention may comprise a monomeric unit from group b and a monomeric unit from group d.

In still another example, the polymer of the present invention may comprise a monomeric unit from group c and a monomeric unit from group d.

In yet another example, the polymer of the present invention may comprise a monomeric unit from group a, a monomeric unit from group b, and a monomeric unit from group c.

In even another example, the polymer of the present invention may comprise a monomeric unit from group a, a monomeric unit from group b, and a monomeric unit from group d.

In yet another example, the polymer of the present invention may comprise a monomeric unit from group a, a monomeric unit from group c, and a monomeric unit from group d.

In another example, the polymer of the present invention may comprise a monomeric unit from group b, a monomeric unit from group c, and a monomeric unit from group d.

In even yet another example, the polymer of the present invention may comprise a monomeric unit from group a, a monomeric unit from group b, a monomeric unit from group c and a monomeric unit from group d.

In one example, when present in the polymer, the monomeric unit from group b and the monomeric unit from group c are present in the polymer at a molar ratio of from about 3:1 to 1:3 and/or from about 2:1 to 1:2 and/or from about 1.3:1 to 1:1.3 and/or about 1:1 or less or about 1:1 or more.

In another example, when present in the polymer, the monomeric unit from group b and the monomeric unit from group d are present in the polymer at a molar ratio of from about 3:1 to 1:3 and/or from about 2:1 to 1:2 and/or from about 1.3:1 to 1:1.3 and/or about 1:1 or less or about 1:1 or more.

In another example, when present in the polymer, the monomeric unit from group c and the monomeric unit from group d are present in the polymer at a molar ratio of from about 3:1 to 1:3 and/or from about 2:1 to 1:2 and/or from about 1.3:1 to 1:1.3 and/or about 1:1 or less or about 1:1 or more.

In still another example, the polymer comprises a monomeric unit from group a and a monomeric unit from group c. For example, the polymer may comprise an acrylamide monomeric unit and a quaternary ammonium monomeric unit. The quaternary monomeric unit may be selected from the group consisting of: monoquaternary ammonium monomeric units, diquaternary ammonium monomeric units, and triquaternary ammonium monomeric units. In one example, the polymer may comprise at least 69.9% wt of the monomeric unit from group a and no more than 30.1% wt of the monomeric unit from group c.

In still another example, the polymer comprises a monomeric unit from group a and a monomeric unit from group b. For example, the polymer may comprise an acrylamide monomeric unit and an acrylic acid monomeric unit. In one example, the polymer may comprise at least 69.9% wt of the monomeric unit from group a and no more than 30.1% wt of the monomeric unit from group b.

In yet another example, the polymer comprises a monomeric unit from group b and a monomeric unit from group c. For example, the polymer may comprise an anionic monomeric unit derived from an anionic monomer selected from the group consisting of: acrylic acid, methacrylic acid, 2-acrylamido-2-methylpropane sulfonic acid, carboxyethyl acrylate, and mixtures thereof and a quaternary ammonium monomeric unit. The quaternary ammonium monomeric unit may be derived from a quaternary monomer selected from the group consisting of: monoquaternary ammonium monomeric units, diquaternary ammonium monomeric units, triquaternary ammonium monomeric units, and mixtures thereof. In one example, the polymer comprises an anionic monomeric unit derived from acrylic acid and a quaternary ammonium monomeric unit derived from MAPTAC. In one example, the polymer may comprise no more than 25% wt of the monomeric unit from group b and no more than 75% wt of the monomeric unit from group c.

In even yet another example, the polymer comprises a monomeric unit from group a and a monomeric unit from group b and a monomer unit from group c. For example, the polymer may comprise an acrylamide monomeric unit, and an anionic monomeric unit derived from an anionic monomer selected from the group consisting of: acrylic acid, methacrylic acid, 2-acrylamido-2-methylpropane sulfonic acid, carboxyethyl acrylate, and mixtures thereof and a quaternary ammonium monomeric unit. The quaternary ammonium monomeric unit may be derived from a quaternary monomer selected from the group consisting of: monoquaternary ammonium monomeric units, diquaternary ammonium monomeric units, triquaternary ammonium monomeric units, and mixtures thereof. In one example, the polymer comprises a nonionic monomeric unit derived from acrylamide, an anionic monomeric unit derived from acrylic acid, and a cationic monomeric unit derived from MAPTAC. In another example, the polymer comprises a nonionic monomeric unit derived from acrylamide, an anionic monomeric unit derived from acrylic acid, and a cationic monomeric unit derived from DADMAC. In still another example, the polymer comprises a nonionic monomeric unit derived from acrylamide, an anionic monomeric unit derived from acrylic acid, and a cationic monomeric unit derived from TQ. In another example, the polymer comprises a nonionic monomeric unit derived from acrylamide, an anionic monomeric unit derived from CEA, and a cationic monomeric unit derived from MAPTAC. In still another example, the polymer comprises a nonionic monomeric unit derived from acrylamide, an anionic monomeric unit derived from AMPS, and a cationic monomeric unit derived from MAPTAC. In one example, the polymer may comprise at least 69.9% wt of the monomeric unit from group a and no more than 30.1% wt combined of the monomeric units from groups b and c. In another example, the polymer may comprise from about 70% to about 99.5% wt of the monomeric unit from group a, from 0.1% to about 30% wt of the monomeric unit from group b, and from about 0.1% to about 30% wt of the monomeric unit from group c. In still another example, the polymer may comprise from about 70% to about 99.5% wt of the monomeric unit from group a and from about 0.5% to 30% wt combined of the monomeric units from groups b and c.

In even still yet another example, the polymer comprises a monomeric unit from group a and a monomeric unit from group c and a monomer unit from group d. For example, the polymer may comprise an acrylamide monomeric unit, a quaternary ammonium monomeric unit, and a zwitterionic monomeric unit selected from the group consisting of: CZ, SZ, and mixtures thereof. The quaternary ammonium monomeric unit may be derived from a quaternary monomer selected from the group consisting of: monoquaternary ammonium monomeric units, diquaternary ammonium monomeric units, triquaternary ammonium monomeric units, and mixtures thereof. In one example, the polymer comprises a nonionic monomeric unit derived from acrylamide, a cationic monomeric unit derived from MAPTAC, and a zwitterionic monomeric unit derived from CZ. In another example, the polymer comprises a nonionic monomeric unit derived from acrylamide, a cationic monomeric unit derived from MAPTAC, and a zwitterionic monomeric unit derived from SZ. In one example, the polymer may comprise at least 69.9% wt of the monomeric unit from group a and no more than 30.1% wt combined of the monomeric units from groups c and d. In another example, the polymer may comprise from about 70% to about 99.5% wt of the monomeric unit from group a, from 0.1% to about 30% wt of the monomeric unit from group c, and from about 0.1% to about 30% wt of the monomeric unit from group d. In still another example, the polymer may comprise from about 70% to about 99.5% wt of the monomeric unit from group a and from about 0.5% to 30% wt combined of the monomeric units from groups c and d.

In even yet another example, the polymer comprises a monomeric unit from group a and a monomeric unit from group b and a monomer unit from group d. For example, the polymer may comprise an acrylamide monomeric unit, and an anionic monomeric unit derived from an anionic monomer selected from the group consisting of: acrylic acid, methacrylic acid, 2-acrylamido-2-methylpropane sulfonic acid, carboxyethyl acrylate, and mixtures thereof and a zwitterionic monomeric unit selected from the group consisting of: CZ, SZ, and mixtures thereof. In one example, the polymer comprises a nonionic monomeric unit derived from acrylamide, an anionic monomeric unit derived from acrylic acid, and zwitterionic monomeric unit derived from CZ. In another example, the polymer comprises a nonionic monomeric unit derived from acrylamide, an anionic monomeric unit derived from acrylic acid, and a zwitterionic monomeric unit derived from SZ. In one example, the polymer may comprise at least 69.9% wt of the monomeric unit from group a and no more than 30.1% wt combined of the monomeric units from groups b and d. In another example, the polymer may comprise from about 70% to about 99.5% wt of the monomeric unit from group a, from 0.1% to about 30% wt of the monomeric unit from group b, and from about 0.1% to about 30% wt of the monomeric unit from group d. In still another example, the polymer may comprise from about 70% to about 99.5% wt of the monomeric unit from group a and from about 0.5% to 30% wt combined of the monomeric units from groups b and d.

In even yet another example, the polymer comprises a monomeric unit from group a and a monomeric unit from group d. For example, the polymer may comprise an acrylamide monomeric unit, and a zwitterionic monomeric unit selected from the group consisting of: CZ, SZ, and mixtures thereof. In one example, the polymer comprises a nonionic monomeric unit derived from acrylamide and zwitterionic monomeric unit derived from CZ. In another example, the polymer comprises a nonionic monomeric unit derived from acrylamide and a zwitterionic monomeric unit derived from SZ. In one example, the polymer may comprise at least 69.9% wt of the monomeric unit from group a and no more than 30.1% wt of the monomeric unit from group d. In another example, the polymer may comprise from about 70% to about 99.5% wt of the monomeric unit from group a, from 0.5% to about 30% wt of the monomeric unit from group d.

In one example, the polymer of the present invention comprises a nonionic hydrophilic monomeric unit. Non-limiting examples of suitable hydrophilic monomeric units are derived from nonionic hydrophilic monomers selected from the group consisting of: hydroxyalkyl esters of α,β-ethylenically unsaturated acids, α,β-ethylenically unsaturated amides, α,β-ethylenically unsaturated monoalkyl amides, α,β-ethylenically unsaturated dialkyl amides, α,β-ethylenically unsaturated monomers bearing a water-soluble polyoxyalkylene segment of the poly(ethylene oxide) type, α,β-ethylenically unsaturated monomers which are precursors of hydrophilic units or segments, vinylpyrrolidones, α,β-ethylenically unsaturated monomers of the ureido type, and mixtures thereof. In one example, the nonionic hydrophilic monomeric unit is derived from acrylamide.

In another example, the polymer of the present invention comprises a nonionic hydrophobic monomeric unit. Non-limiting examples of suitable nonionic hydrophobic monomeric units are derived from nonionic hydrophobic monomers selected from the group consisting of: vinylaromatic monomers, vinyl halides, vinylidene halides, C₁-C₁₂ alkylesters of α,β-monoethylenically unsaturated acids, vinyl esters of saturated carboxylic acids, allyl esters of saturated carboxylic acids, α,β-monoethylenically unsaturated nitriles containing from 3 to 12 carbon atoms, α-olefins, conjugated dienes, and mixtures thereof.

In one example, the polymer comprises an anionic monomeric unit. Non-limiting examples of suitable anionic monomeric units are derived from anionic monomers selected from the group consisting of: monomers having at least one carboxylic function, for instance α,β-ethylenically unsaturated carboxylic acids or the corresponding anhydrides, monomers that are precursors of carboxylate functions, monomers having at least one sulfate or sulfonate function, monomers having at least one phosphonate or phosphate function, esters of ethylenically unsaturated phosphates, and mixtures thereof. In one example, the anionic monomeric unit is derived from an anionic monomer selected from the group consisting of: acrylic acid, methacrylic acid, 2-acrylamido-2-methylpropane sulfonic acid, carboxyethyl acrylate, and mixtures thereof.

In one example, the polymer comprises a cationic monomeric unit. Non-limiting examples of suitable cationic monomeric units are derived from cationic monomers selected from the group consisting of: acryloyl- or acryloyloxyammonium monomers, 1-ethyl-2-vinylpyridinium or 1-ethyl-4-vinylpyridinium bromide, chloride or methyl sulfate, N,N-dialkyldiallylamine monomers, polyquaternary monomers, N,N-(dialkylamino-ω-alkyl)amides of α,β-monoethylenically unsaturated carboxylic acids, α,β-monoethylenically unsaturated amino esters, vinylpyridines, vinylamine, vinylimidazolines, monomers that are precursors of amine functions which give rise to primary amine functions by simple acid or base hydrolysis, and mixtures thereof. In one example, the cationic monomeric unit is derived from MAPTAC. In another example, the cationic monomeric unit is derived from DADMAC. In still another example, the cationic monomeric unit is derived from 2-hydroxy-N¹-(3-(2((3-methacrylamidopropyl)dimethylammino)-acetamido)prop N¹,N¹,N³,N³,N³-pentamethylpropane-1,3-diaminium chloride.

### Process for Making Polymers

The polymers of the present invention may be made by any suitable process known in the art. For example, the polymer may be made by radical polymerization.

The polymers of the present invention can be made by a wide variety of techniques, including bulk, solution, emulsion, or suspension polymerization. Polymerization methods and techniques for polymerization are described generally in Encyclopedia of Polymer Science and Technology, Interscience Publishers (New York), Vol. 7, pp. 361-431 (1967), and Kirk-Othmer Encyclopedia of Chemical Technology, 3rd edition, Vol 18, pp. 740-744, John Wiley & Sons (New York), 1982, both incorporated by reference herein. See also Sorenson, W. P. and Campbell, T. W., Preparative Methods of Polymer Chemistry. 2nd edition, Interscience Publishers (New York), 1968, pp. 248-251, incorporated by reference herein, for general reaction techniques suitable for the present invention. In one example, the polymers are made by free radical copolymerization, using water soluble initiators. Suitable free radical initiators include, but are not limited to, thermal initiators, redox couples, and photochemical initiators. Redox and photochemical initiators may be used for polymerization processes initiated at temperatures below about 30° C. (86° F.). Such initiators are described generally in Kirk-Othmer Encyclopedia of Chemical Technology, 3rd edition, John Wiley & Sons (New York), Vol. 13, pp. 355-373 (1981), incorporated by reference herein. Typical water soluble initiators that can provide radicals at 30° C. or below include redox couples, such as potassium persulfate/silver nitrate, and ascorbic acid/hydrogen peroxide. In one example, the method utilizes thermal initiators in polymerization processes conducted above 40° C. (104° F.). Water soluble initiators that can provide radicals at 40° C. (104° F.) or higher can be used. These include, but are not limited to, hydrogen peroxide, ammonium persulfate, and 2,2′-azobis(2-amidinopropane) dihydrochloride. In one example, water soluble starting monomers are polymerized in an aqueous alcohol solvent at 60° C. (140° F.) using 2,2′-azobis(2-amidinopropane) dihydrochloride as the initiator. The solvent should typically contain at least about 10% by volume, of alcohol in order to prevent the polymerization reaction medium from gelling. Suitable alcohols for use in such reaction include low molecular weight alcohols such as, but not limited to, methanol, ethanol, isopropanol, and butanol.

Another technique is a solution polymerization as described in U.S. Pat. No. 3,317,370, Kekish, issued May 2, 1967 and U.S. Pat. No. 3,410,828, Kekish, issued Nov. 12, 1968, both incorporated herein by reference. According to such process, the acrolein, or other aldehydic monomer, is copolymerized with a non-nucleophilic, water soluble, nitrogen-heterocyclic polymerizable monomer and a redox initiator system. The copolymer is then made cationic by reacting the copolymer with a water soluble amine or amine quaternary. Amines, including amine quaternaries, that are useful include, but are not limited to, primary, secondary, and tertiary amines such as ethylene diamine, diethylene triamine, triethylene tetramine, tetraethylene pentamine, or partial or fully quaternized derivatives of any of the foregoing, hydrazides and quaternaries thereof such as betaine hydrazide chloride, N—N-dimethylglycine hydrazide, unsymmetrical dimethyl hydrazides, polymers, such as those formed by reaction of urea and polyalkylene polyamines, guanidines, biguanides, guanylureas, mono and polyhydroxy polyamines and quaternaries thereof, etc. When using this emulsion copolymerization technique, it will be necessary to control molecular weight to within the ranges provided herein.

In one example, a method for making a polymer according to the present invention comprises the steps of:
i. providing two or more monomeric units selected from the group consisting of:
   a. nonionic monomeric units;
   b. anionic monomeric units;
   c. cationic monomeric units;
   d. zwitterionic monomeric units; and
   e. mixtures thereof; and
ii. polymerizing the two or more monomeric units such that a polymer that exhibits a Soil Adsorption Value of at least 38 mg as measured according to the Soil Adsorption Test Method described herein is produced. In one example, the step of polymerizing comprises the step of mixing the two or more monomeric units or the monomers from which they are derived with water to form a monomer solution and polymerizing the monomers to form a polymer solution. The monomer solution and/or polymer solution may be deoxygenated. In addition, the monomer solution and/or polymer solution may be subjected (heated) to a temperature of at least 25° C., such as 60° C. The temperatures used to make the polymer may be any suitable temperature so long as a polymer according to the present invention is produced. The monomer solution and/or polymer solution may be subject to such temperature for a time sufficient to polymerize the monomeric units into a polymer, for example at least 10 minutes, and/or at least 18 hours depending on the reaction conditions. An initiator, such as a free-radical initiator, may be added to the monomer solution and/or polymer solution to polymerize the monomeric units (monomers) within the monomer solution to produce a polymer of the present invention. The levels of free radical initiator(s) used to make the polymer may be any suitable level so long as a polymer according to the present invention is produced. The levels of the various monomeric units (monomers) used to make the polymer may be any suitable level so long as a polymer according to the present invention is produced.

### Non-Limiting Synthesis Examples

### Sample Preparation

### Initiator Solution Preparation

10 ml of water is added to a flask along with 1 gram of 2,2′-azobis(2-methylpropionamidine) dihydrochloride (available from Wako Chemicals), herein called V-50. This solution is sparged with argon gas to remove oxygen.

### Monomer Preparation

### Synthesis of 2-Hydroxy-N¹-(3-(2-((3-Methacrylamidopropyl)Dimethylammonio)-Acetamido)Propyl)-N¹,N¹,N³,N³,N³-Pentamethylpropane-1,3-Diaminium Chloride (Herein Called (TQ)

To a jacketed round bottom flask equipped with mechanical stirrer, gas inlet, condenser and thermometer is added 340.6 grams of dimethylamino propyl methacrylamide (DMAPMA, available from Sigma-Aldrich), 238.8 grams of methyl chloroacetate (available from Sigma-Aldrich), 0.5 g 4-methoxy phenol (available from Sigma-Aldrich), and 423 grams of methanol (available from Sigma-Aldrich). The round bottom flask is heated at 70° C. for 5 hours. This reaction is cooled to room temperature and then 0.5 grams of 4-methoxy phenol (available from Sigma-Aldrich) and 225 grams of dimethylaminoipropylamine (available from Sigma-Aldrich) is added evenly over a 2 hour period. After 2 hours the reaction is heated to 65° C. for 2 hours after which methanol is distilled out at 50° C. under vacuum. To this is added 690 grams of (3-chloro-2-hydroxypropyl)trimethylammonium chloride (available as a 60% aqueous solution from Sigma-Aldrich). The temperature is maintained at 65-70° C. for 2 hours. During these 2 hours methanol is stripped out and water is added to make a 55% solution in water based on weight. The reaction is continued in water at 65-70° C. for another hour to yield the TQ monomer.

### Synthesis of 3-((3-Methacrylamidopropyl)Dimethylammonio)Propane-1-Sulfonate (Herein Called SZ)

Into a round bottom flask is added 26.4 grams of anhydrous acetonitrile (available from Sigma-Aldrich) and 15.5 grams of propane sultone (available from Sigma-Aldrich), and this is stirred for 30 minutes. After the 30 minutes, a solution of 25.6 grams of DMAPMA in 56.5 grams of acetonitrile is added. The mixture is stirred and warmed to 35° C. A white precipitate quickly forms. Once the white precipitate takes up the bulk of the volume, the liquid is decanted. The solid is washed once with acetonitrile and again the liquid is removed by decanting. The solids are then washed in 2× volume diethyl ether. They are then filtered via funnel and washed with copious amounts (via filtration) of diethyl ether. The NMR structure is consistent with the structure of the target molecule SZ.

### Synthesis of N-(Carboxymethyl)-3-Methacrylamido-N,N-Dimethylpropan-1-Aminium Chloride (Herein Called CZ)

To a round bottom flask is added 16.5 grams of methyl bromoacetate (available from Sigma-Aldrich), 74 grams of tetrahydrofuran (THF, available from Sigma-Aldrich), and 16.5 grams of DMAPMA. The solution is stirred for 16 hours at 25° C., and then the stirring is discontinued. After settling, the top layer of THF is discarded. The lower layer is washed with 50 mL of hexanes (available from Sigma-Aldrich) twice and becomes a viscous material. The material is then dissolved in 15 mL of methanol (available from Sigma-Aldrich) and precipitated into 150 mL of diethyl ether (available from Sigma-Aldrich). The precipitate is washed several times with diethylether until it becomes a viscous semi-solid. It is then dried overnight under high vacuum at room temperature. A small portion is taken for NMR analysis. The remainder of the intermediate is placed in a glass desiccator containing calcium chloride until the next step.

3.3 grams of the intermediate from above is dissolved in 10 mL of deionized water and run through a column consisting of 50 mL of Dowex Marathon A hydroxide exchange resin (available from VWR Scientific) in a glass column of 2.5 cm diameter at 2.7 mL/min. The effluent is collected and 13 mL of 1N hydrochloric acid (available from Sigma-Aldrich) is added. The water is dried off under vacuum at room temperature. The sample is then dried overnight under high vacuum at room temperature. The material is removed from the vacuum and a small portion is taken for NMR analysis. 2.71 g of deionized water is added to the material to form the finished product CZ which is stored as a solution in water.

### Polymer Preparation

Into a reaction vessel are added the monomers in the amounts listed for the examples in Table 1 below and 456 g of water. The monomers, acrylamide (herein called AAM), acrylic acid (herein called AA), diallyldimethylammonium chloride (herein called DADMAC), 2-carboxy ethyl acrylate (herein called CEA), 2-acrylamido-2-methylpropane sulfonic acid (herein called AMPS) and [3-(methyacryloylamino)propyl] trimethylammonium chloride (herein called MAPTAC), are all available from Sigma Aldrich. MAPTAC is used as a 50% w/w solution. TQ, SZ and CZ are used as prepared above. The reaction vessel is sparged with nitrogen to remove oxygen from the system and a nitrogen atmosphere is maintained in the vessel. The reaction vessel and contents are heated to a temperature of 60° C.

Once the contents have reached 60° C., the initiator solution 1 mL of the V-50 as prepared above is added as a 10% solution (except for Example 1.17 which used 0.0562 g of V-50 neat). The reaction is kept at 60° C. for 48 hours.

The following tables set forth non-limiting examples of polymers of the present invention that were made.

TABLE 1
Examples: Polymer Construction Data

| | AAM | AA | MAPTAC | DADMAC | TQ | CEA | AMPS | SZ | CZ |
|---|---|---|---|---|---|---|---|---|---|
| Ex. | (g) | (g) | (g) | (g) | (g) | (g) | (g) | (g) | (g) |
| 1.1 | 21.60 | 0.00 | 2.40 | 0.00 | 0.00 | 0.00 | 0.00 | 0.00 | 0.00 |
| 1.2 | 21.60 | 0.31 | 2.09 | 0.00 | 0.00 | 0.00 | 0.00 | 0.00 | 0.00 |
| 1.3 | 21.60 | 0.60 | 1.81 | 0.00 | 0.00 | 0.00 | 0.00 | 0.00 | 0.00 |
| 1.4 | 21.60 | 1.20 | 1.21 | 0.00 | 0.00 | 0.00 | 0.00 | 0.00 | 0.00 |
| 1.5 | 21.60 | 1.80 | 0.61 | 0.00 | 0.00 | 0.00 | 0.00 | 0.00 | 0.00 |
| 1.6 | 21.59 | 2.40 | 0.00 | 0.00 | 0.00 | 0.00 | 0.00 | 0.00 | 0.00 |
| 1.7 | 0.00 | 6.00 | 18.00 | 0.00 | 0.00 | 0.00 | 0.00 | 0.00 | 0.00 |
| 1.8 | 2.41 | 5.40 | 16.20 | 0.00 | 0.00 | 0.00 | 0.00 | 0.00 | 0.00 |
| 1.9 | 7.20 | 4.20 | 12.60 | 0.00 | 0.00 | 0.00 | 0.00 | 0.00 | 0.00 |
| 1.10 | 12.00 | 3.00 | 9.00 | 0.00 | 0.00 | 0.00 | 0.00 | 0.00 | 0.00 |
| 1.11 | 16.79 | 1.81 | 5.42 | 0.00 | 0.00 | 0.00 | 0.00 | 0.00 | 0.00 |
| 1.12 | 19.22 | 1.20 | 3.60 | 0.00 | 0.00 | 0.00 | 0.00 | 0.00 | 0.00 |
| 1.13 | 20.41 | 0.90 | 2.70 | 0.00 | 0.00 | 0.00 | 0.00 | 0.00 | 0.00 |
| 1.14 | 21.61 | 0.60 | 1.80 | 0.00 | 0.00 | 0.00 | 0.00 | 0.00 | 0.00 |
| 1.15 | 22.81 | 0.31 | 0.92 | 0.00 | 0.00 | 0.00 | 0.00 | 0.00 | 0.00 |
| 1.16 | 23.51 | 0.12 | 0.36 | 0.00 | 0.00 | 0.00 | 0.00 | 0.00 | 0.00 |
| 1.17 | 23.75 | 0.06 | 0.18 | 0.00 | 0.00 | 0.00 | 0.00 | 0.00 | 0.00 |
| 1.18 | 23.76 | 0.06 | 0.18 | 0.00 | 0.00 | 0.00 | 0.00 | 0.00 | 0.00 |
| 1.19 | 23.87 | 0.03 | 0.10 | 0.00 | 0.00 | 0.00 | 0.00 | 0.00 | 0.00 |
| 1.20 | 24.09 | 0.00 | 0.00 | 0.00 | 0.00 | 0.00 | 0.00 | 0.00 | 0.00 |
| 1.21 | 23.76 | 0.07 | 0.00 | 0.17 | 0.00 | 0.00 | 0.00 | 0.00 | 0.00 |
| 1.22 | 23.77 | 0.0285 | 0.00 | 0.00 | 0.212 | 0.00 | 0.00 | 0.00 | 0.00 |
| 1.23 | 23.76 | 0.00 | 0.145 | 0.00 | 0.00 | 0.0939 | 0.00 | 0.00 | 0.00 |
| 1.24 | 23.76 | 0.00 | 0.13 | 0.00 | 0.00 | 0.00 | 0.12 | 0.00 | 0.00 |
| 1.25 | 23.77 | 0.00 | 0.00 | 0.00 | 0.00 | 0.00 | 0.00 | 0.252 | 0.00 |
| 1.26 | 23.76 | 0.00 | 0.00 | 0.00 | 0.00 | 0.00 | 0.00 | 0.00 | 0.240 |
| 1.27 | 23.52 | 0.00 | 0.00 | 0.00 | 0.00 | 0.00 | 0.00 | 0.00 | 0.479 |
| 1.28 | 23.76 | 0.00 | 0.003 | 0.00 | 0.00 | 0.00 | 0.00 | 0.00 | 0.240 |
| 1.29 | 23.76 | 0.002 | 0.00 | 0.00 | 0.00 | 0.00 | 0.00 | 0.00 | 0.240 |

TABLE 2
Examples: Polymer Solution Data

| | | | | Polymer | |
|---|---|---|---|---|---|
| | | | Polymer | Solution + | |
| | | Solids | Solution | Water | Conc. |
| Ex. | Mass Composition of Monomers | (%) | (g) | (g) | (%) |
| 2.1 | 90% AAM, 10% MAPTAC | 5.44 | 0.4253 | 115.68 | 0.02 |
| 2.2 | 90% AAM, 1.3% AA, 8.7% MAPTAC | 5.41 | 0.3927 | 106.24 | 0.02 |
| 2.3 | 90% AAM, 2.5% AA, 7.5% MAPTAC | 5.45 | 0.4013 | 109.34 | 0.02 |
| 2.4 | 90% AAM, 5% AA, 5% MAPTAC | 5.43 | 0.3974 | 107.89 | 0.02 |
| 2.5 | 90% AAM, 7.5% AA, 2.5% MAPTAC | 5.42 | 0.7522 | 203.84 | 0.02 |
| 2.6 | 90% AAM, 10% AA | 5.42 | 0.3985 | 108.00 | 0.02 |
| 2.7 | 25% AA, 75% MAPTAC | 5.25 | 0.3823 | 100.36 | 0.02 |
| 2.8 | 10% AAM, 22.5% AA, 67.5% MAPTAC | 5.24 | 0.3788 | 99.27 | 0.02 |
| 2.9 | 30% AAM, 17.5% AA, 52.5% MAPTAC | 5.26 | 0.3979 | 104.64 | 0.02 |
| 2.10 | 50% AAM, 12.5% AA, 37.5% MAPTAC | 5.36 | 0.3692 | 98.95 | 0.02 |
| 2.11 | 69.9% AAM, 7.5% AA, 22.6% | 5.30 | 0.3810 | 100.97 | 0.02 |
| | MAPTAC | | | | |
| 2.12 | 80% AAM, 5% AA, 15% MAPTAC | 5.31 | 0.3899 | 103.53 | 0.02 |
| 2.13 | 85% AAM, 3.7% AA, 11.3% MAPTAC | 5.30 | 0.4403 | 116.69 | 0.02 |
| 2.14 | 90% AAM, 2.5% AA, 7.5% MAPTAC | 5.26 | 0.3800 | 99.93 | 0.02 |
| 2.15 | 94.9% AAM, 1.3% AA, 3.8% MAPTAC | 5.34 | 0.3982 | 106.34 | 0.02 |
| 2.16 | 98% AAM, 0.5% AA, 1.5% MAPTAC | 2.54 | 0.7969 | 101.21 | 0.02 |
| 2.17 | 99% AAM, 0.25% AA, 0.75% MAPTAC | 2.56 | 0.7944 | 101.68 | 0.02 |
| 2.18 | 99% AAM, 0.25% AA, 0.75% MAPTAC | 5.32 | 0.3751 | 100.49 | 0.02 |
| 2.19 | 99.5% AAM, 0.125% AA, 0.375% | 2.57 | 0.7850 | 100.89 | 0.02 |
| | MAPTAC | | | | |
| 2.20 | 100% AAM (Comparative Example) | 5.23 | 0.3979 | 104.02 | 0.02 |
| 2.21 | 99% AAM, 0.3% AA, 0.7% DADMAC | 5.40 | 0.3876 | 104.70 | 0.02 |
| 2.22 | 99% AAM, 0.12% AA, 0.88% TQ | 5.16 | 3.8100 | 980.46 | 0.02 |
| 2.23 | 99.01% AAM, 0.39% CEA, 0.6% | 5.27 | 0.3914 | 103.13 | 0.02 |
| | MAPTAC | | | | |
| 2.24 | 99% AAM, 0.5% AMPS, 0.5% | 5.40 | 0.3823 | 103.22 | 0.02 |
| | MAPTAC | | | | |
| 2.25 | 98.95% AAM, 1.05% SZ | 5.29 | 0.3791 | 100.25 | 0.02 |
| 2.26 | 99% AAM, 1% CZ | 5.28 | 0.4004 | 105.73 | 0.02 |
| 2.27 | 98% AAM, 2% CZ | 5.13 | 0.4055 | 104.15 | 0.02 |
| 2.28 | 98.99% AAM, 0.01% MAPTAC, 1% CZ | 5.15 | 0.5177 | 133.36 | 0.02 |
| 2.29 | 98.99% AAM, 0.01% AA, 1% CZ | 5.14 | 0.5941 | 152.90 | 0.02 |
| 2.30 | Mirapol ® HSC300 (Comparative | 20.81 | 0.1378 | 143.38 | 0.02 |
| | Example) | | | | |
| 2.31 | Deionized Water (Control) | | | | |

TABLE 3
Examples: Substrate Data

| | | Minimum gsm for | Maximum gsm for 3 |
|---|---|---|---|
| | | 3 inch × 4 inch | inch × 4 inch |
| Ex. | Substrate | Specimen | Specimen |
| 3.A | Scott Paper Towel | 39.5 | 40.7 |
| 3.B | Bounty Paper Towel | 47.7 | 50.6 |
| 3.C | Viva Paper Towel | 65.1 | 67.8 |
| 3.D | Bounty Quilted Napkins | 87.4 | 91.6 |
| 3.E | Swiffer Sweeper Wet | 48.8 | 58.9 |
| 3.F | Swiffer WetJet Pad | 189.6 | 222.2 |
| 3.G | Clorox Ready Mop | 82.5 | 98.0 |
| 3.H | O-Cel-O Sponge | 59.4 | 89.3 |
| 3.I | Lysol Cleaning Wipe | 47.1 | 50.5 |
| 3.J | Clorox Cleaning Wipe | 53.7 | 60.8 |
| 3.K | Mr. Clean Wipe | 46.2 | 57.7 |
| 3.L | Windex Original Wipe | 60.1 | 62.9 |
| 3.M | Pampers Baby Wipe | 46.2 | 54.6 |
| 3.N | Huggies Baby Wipe | 59.4 | 71.7 |
| 3.O | Clorox Handi Wipe | 40.7 | 50.1 |
| 3.P | Shout Color Catcher | 60.8 | 69.0 |
| 3.Q | VWR Cheesecloth | 113.7 | 124.3 |
| 3.R | VWR Cotton Pad | 110.1 | 125.3 |
| 3.S | Mainstays Flour Sack | 109.8 | 123.2 |
| 3.T | Handsheet | 19 | 33 |

TABLE 4
Test Results

| | | | | Soil | | % | |
|---|---|---|---|---|---|---|---|
| | | | | Adsorption | St | Soil | St |
| | | | | Value | Dev | Retained_{avg} | Dev |
| Ex. | Mass Composition of Monomers | Mn | PDI | (mg) | (mg) | (%) | (%) |
| 4.1 | 90% AAM, 10% MAPTAC | 1,211,000 | 1.240 | 41 | 1 | 23 | 1 |
| 4.2 | 90% AAM, 1.3% AA, 8.7% MAPTAC | 948,200 | 1.239 | 42 | 6 | 24 | 3 |
| 4.3 | 90% AAM, 2.5% AA, 7.5% MAPTAC | 852,500 | 1.351 | 47 | 2 | 26 | 1 |
| 4.4 | 90% AAM, 5% AA, 5% MAPTAC | 753,500 | 1.402 | 40 | 3 | 23 | 2 |
| 4.5 | 90% AAM, 7.5% AA, 2.5% MAPTAC | 970,300 | 1.271 | 43 | 3 | 24 | 2 |
| 4.6 | 90% AAM, 10% AA | 1,021,000 | 1.222 | 46 | 1 | 26 | 0 |
| 4.7 | 25% AA, 75% MAPTAC | 201,500 | 1.823 | 44 | 3 | 24 | 2 |
| 4.8 | 10% AAM, 22.5% AA, 67.5% | 226,400 | 1.712 | 32 | 1 | 18 | 1 |
| | MAPTAC (Comparative Example) | | | | | | |
| 4.9 | 30% AAM, 17.5% AA, 52.5% | 311,800 | 1.604 | 32 | 2 | 18 | 1 |
| | MAPTAC (Comparative Example) | | | | | | |
| 4.10 | 50% AAM, 12.5% AA, 37.5% | 583,800 | 1.406 | 34 | 3 | 19 | 2 |
| | MAPTAC (Comparative Example) | | | | | | |
| 4.11 | 69.9% AAM, 7.5% AA, 22.6% | | | 38 | 1 | 21 | 1 |
| | MAPTAC | | | | | | |
| 4.12 | 80% AAM, 5% AA, 15% MAPTAC | 821,000 | 1.269 | 40 | 1 | 23 | 1 |
| 4.13 | 85% AAM, 3.7% AA, 11.3% MAPTAC | 865,600 | 1.241 | 44 | 3 | 25 | 2 |
| 4.14 | 90% AAM, 2.5% AA, 7.5% MAPTAC | | | 45 | 0 | 25 | 0 |
| 4.15 | 94.9% AAM, 1.3% AA, 3.8% MAPTAC | 927,100 | 1.222 | 53 | 3 | 30 | 1 |
| 4.16 | 98% AAM, 0.5% AA, 1.5% MAPTAC | | | 55 | 3 | 31 | 2 |
| 4.17 | 99% AAM, 0.25% AA, 0.75% | 858,100 | 1.302 | 57 | 3 | 32 | 2 |
| | MAPTAC | | | | | | |
| 4.18 | 99% AAM, 0.25% AA, 0.75% | 814,200 | 1.293 | 57 | 5 | 32 | 3 |
| | MAPTAC | | | | | | |
| 4.19 | 99.5% AAM, 0.125% AA, 0.375% | 1,212,000 | 1.285 | 65 | 3 | 36 | 2 |
| | MAPTAC | | | | | | |
| 4.20 | 100% AAM (Comparative Example) | 1,116,600 | 1.204 | 40 | 3 | 22 | 2 |
| 4.21 | 99% AAM, 0.3% AA, 0.7% DADMAC | 520,400 | 1.432 | 53 | 4 | 30 | 2 |
| 4.22 | 99% AAM, 0.12% AA, 0.88% TQ | 1,050,000 | 1.165 | 54 | 2 | 30 | 1 |
| 4.23 | 99.01% AAM, 0.39% CEA, 0.6% | 791,200 | 1.219 | 61 | 4 | 34 | 2 |
| | MAPTAC | | | | | | |
| 4.24 | 99% AAM, 0.5% AMPS, 0.5% | 644,400 | 1.579 | 59 | 2 | 33 | 1 |
| | MAPTAC | | | | | | |
| 4.25 | 98.95% AAM, 1.05% SZ | 542,800 | 1.566 | 54 | 4 | 30 | 2 |
| 4.26 | 99% AAM, 1% CZ | 862,700 | 1.269 | 57 | 3 | 32 | 1 |
| 4.27 | 98% AAM, 2% CZ | | | 62 | 2 | 35 | 1 |
| 4.28 | 98.99% AAM, 0.01% MAPTAC, 1% CZ | | | 60 | 4 | 33 | 2 |
| 4.29 | 98.99% AAM, 0.01% AA, 1% CZ | | | 60 | 2 | 33 | 1 |
| 4.30 | Mirapol ® HSC300* (Comparative | | | 34 | 3 | 19 | 1 |
| | Example) | | | | | | |
| 4.31 | Deionized Water (Control) | | | 20 | 4 | 11 | 2 |

*Mirapol ® HSC 300 was obtained from Rhodia S. A. (Paris, France).

TABLE 5
Test Results (Soil Adsorption Values for an Article or a Portion of an Article)

| | | | Soil | | | |
|---|---|---|---|---|---|---|
| | Mass | | Adsorption | | % Soil | St |
| | Composition of | | Value | St Dev | Retained_{avg} | Dev |
| Ex. | Monomers | Substrate | (mg) | (mg) | (%) | (%) |
| 5.18A | 99% AAM, | Scott Paper Towel | 99 | 3 | 56 | 2 |
| 5.18B | 0.25% AA, | Bounty Paper Towel | 152 | 4 | 85 | 2 |
| 5.18C | 0.75% | Viva Paper Towel | 123 | 9 | 69 | 5 |
| 5.18D | MAPTAC | Bounty Quilted | 154 | 8 | 86 | 4 |
| | | Napkins | | | | |
| 5.18E | | Swiffer Sweeper Wet | 171 | 2 | 96 | 1 |
| 5.18F | | Swiffer WetJet Pad | 91 | 12 | 51 | 7 |
| 5.18G | | Clorox Ready Mop | 145 | 17 | 81 | 10 |
| 5.18H | | O-Cel-O Sponge | 76 | 8 | 43 | 4 |
| 5.18I | | Lysol Cleaning Wipe | 122 | 11 | 68 | 6 |
| 5.18J | | Clorox Cleaning Wipe | 157 | 4 | 88 | 2 |
| 5.18K | | Mr. Clean Wipe | 159 | 2 | 89 | 1 |
| 5.18L | | Windex Original Wipe | 113 | 10 | 63 | 5 |
| 5.18M | | Pampers Baby Wipe | 127 | 5 | 71 | 3 |
| 5.18N | | Huggies Baby Wipe | 143 | 6 | 80 | 3 |
| 5.18O | | Clorox Handi Wipe | 167 | 1 | 94 | 1 |
| 5.18P | | Shout Color Catcher | 71 | 5 | 40 | 3 |
| 5.18Q | | VWR Cheesecloth | 107 | 7 | 60 | 4 |
| 5.18R | | VWR Cotton Pad | 151 | 6 | 85 | 3 |
| 5.18S | | Mainstays Flour Sack | 74 | 8 | 41 | 4 |
| 5.22A | 99% AAM, | Scott Paper Towel | 96 | 5 | 54 | 3 |
| 5.22B | 0.12% AA, | Bounty Paper Towel | 160 | 5 | 90 | 3 |
| 5.22C | 0.88% TQ | Viva Paper Towel | 115 | 5 | 65 | 3 |
| 5.22D | | Bounty Quilted | 155 | 6 | 87 | 4 |
| | | Napkins | | | | |
| 5.22E | | Swiffer Sweeper Wet | 172 | 1 | 97 | 0 |
| 5.22F | | Swiffer WetJet Pad | 81 | 4 | 46 | 2 |
| 5.22G | | Clorox Ready Mop | 136 | 11 | 76 | 6 |
| 5.22H | | O-Cel-O-Sponge | 109 | 9 | 61 | 5 |
| 5.22I | | Lysol Cleaning Wipe | 113 | 3 | 63 | 1 |
| 5.22J | | Clorox Cleaning Wipe | 157 | 1 | 88 | 1 |
| 5.22K | | Mr. Clean Wipe | 161 | 2 | 90 | 1 |
| 5.22L | | Windex Original Wipe | 90 | 10 | 50 | 6 |
| 5.22M | | Pampers Baby Wipe | 134 | 3 | 75 | 2 |
| 5.22N | | Huggies Baby Wipe | 139 | 4 | 78 | 2 |
| 5.22O | | Clorox Handi Wipe | 163 | 5 | 91 | 3 |
| 5.22P | | Shout Color Catcher | 113 | 6 | 64 | 3 |
| 5.22Q | | VWR Cheesecloth | 78 | 1 | 44 | 1 |
| 5.22R | | VWR Cotton Pad | 151 | 3 | 85 | 2 |
| 5.22S | | Mainstays Flour Sack | 50 | 6 | 28 | 4 |
| 5.20A | 100% AAM | Scott Paper Towel | 81 | 1 | 45 | 1 |
| 5.20B | (Comparative | Bounty Paper Towel | 111 | 2 | 62 | 1 |
| 5.20C | Examples) | Viva Paper Towel | 88 | 4 | 49 | 2 |
| 5.20D | | Bounty Quilted | 129 | 7 | 72 | 4 |
| | | Napkins | | | | |
| 5.20E | | Swiffer Sweeper Wet | 134 | 7 | 75 | 4 |
| 5.20F | | Swiffer WetJet Pad | 72 | 3 | 40 | 2 |
| 5.20G | | Clorox Ready Mop | 109 | 7 | 61 | 4 |
| 5.20H | | O-Cel-O Sponge | 68 | 3 | 38 | 2 |
| 5.20I | | Lysol Cleaning Wipe | 126 | 6 | 71 | 3 |
| 5.20J | | Clorox Cleaning Wipe | 155 | 1 | 87 | 1 |
| 5.20K | | Mr. Clean Wipe | 150 | 2 | 84 | 1 |
| 5.20L | | Windex Original Wipe | 61 | 2 | 34 | 1 |
| 5.20M | | Pampers Baby Wipe | 77 | 4 | 43 | 2 |
| 5.20N | | Huggies Baby Wipe | 108 | 4 | 61 | 2 |
| 5.20O | | Clorox Handi Wipe | 118 | 2 | 66 | 1 |
| 5.20P | | Shout Color Catcher | 72 | 5 | 40 | 3 |
| 5.20Q | | VWR Cheesecloth | 68 | 7 | 38 | 4 |
| 5.20R | | VWR Cotton Pad | 104 | 7 | 59 | 4 |
| 5.20S | | Mainstays Flour Sack | 74 | 7 | 42 | 4 |
| 5.30A | Mirapol ® HSC | Scott Paper Towel | 67 | 5 | 38 | 3 |
| 5.30B | 300* | Bounty Paper Towel | 113 | 9 | 63 | 5 |
| 5.30C | (Comparative | Viva Paper Towel | 67 | 1 | 38 | 1 |
| 5.30D | Examples) | Bounty Quilted | 114 | 4 | 64 | 2 |
| | | Napkins | | | | |
| 5.30E | | Swiffer Sweeper Wet | 131 | 6 | 74 | 3 |
| 5.30F | | Swiffer WetJet Pad | 60 | 5 | 34 | 3 |
| 5.30G | | Clorox Ready Mop | 89 | 3 | 50 | 2 |
| 5.30H | | O-Cel-O Sponge | 46 | 5 | 26 | 3 |
| 5.30I | | Lysol Cleaning Wipe | 97 | 8 | 54 | 5 |
| 5.30J | | Clorox Cleaning Wipe | 110 | 6 | 62 | 4 |
| 5.30K | | Mr. Clean Wipe | 152 | 5 | 85 | 3 |
| 5.30L | | Windex Original Wipe | 69 | 2 | 39 | 1 |
| 5.30M | | Pampers Baby Wipe | 69 | 5 | 39 | 3 |
| 5.30N | | Huggies Baby Wipe | 96 | 5 | 54 | 3 |
| 5.30O | | Clorox Handi Wipe | 61 | 4 | 34 | 2 |
| 5.30P | | Shout Color Catcher | 67 | 9 | 37 | 5 |
| 5.30Q | | VWR Cheesecloth | 62 | 5 | 35 | 3 |
| 5.30R | | VWR Cotton Pad | 124 | 9 | 70 | 5 |
| 5.30S | | Mainstays Flour Sack | 48 | 4 | 28 | 2 |
| 5.31A | Deionized | Scott Paper Towel | 37 | 3 | 21 | 2 |
| 5.31B | Water | Bounty Paper Towel | 63 | 4 | 35 | 2 |
| 5.31C | (Control) | Viva Paper Towel | 35 | 3 | 20 | 1 |
| 5.31D | | Bounty Quilted | 72 | 4 | 41 | 2 |
| | | Napkins | | | | |
| 5.31E | | Swiffer Sweeper Wet | 48 | 6 | 27 | 3 |
| 5.31F | | Swiffer WetJet Pad | 40 | 8 | 23 | 5 |
| 5.31G | | Clorox Ready Mop | 34 | 2 | 19 | 1 |
| 5.31H | | O-Cel-O Sponge | 47 | 8 | 26 | 4 |
| 5.31I | | Lysol Cleaning Wipe | 46 | 6 | 26 | 3 |
| 5.31J | | Clorox Cleaning Wipe | 58 | 6 | 32 | 3 |
| 5.31K | | Mr. Clean Wipe | 66 | 6 | 37 | 4 |
| 5.31L | | Windex Original Wipe | 22 | 3 | 12 | 2 |
| 5.31M | | Pampers Baby Wipe | 12 | 4 | 7 | 2 |
| 5.31N | | Huggies Baby Wipe | 29 | 3 | 16 | 2 |
| 5.31O | | Clorox Handi Wipe | 20 | 2 | 11 | 1 |
| 5.31P | | Shout Color Catcher | 58 | 4 | 32 | 2 |
| 5.31Q | | VWR Cheesecloth | 20 | 12 | 11 | 7 |
| 5.31R | | VWR Cotton Pad | 58 | 9 | 32 | 5 |
| 5.31S | | Mainstays Flour Sack | 17 | 4 | 10 | 2 |
| 5.1B | 90% AAM, | Bounty Paper Towel | 104 | 5 | 58 | 3 |
| 5.1F | 10% MAPTAC | Swiffer WetJet Pad | 65 | 3 | 37 | 2 |
| 5.1J | | Clorox Cleaning Wipe | 152 | 3 | 85 | 2 |
| 5.2B | 90% AAM, | Bounty Paper Towel | 115 | 4 | 64 | 2 |
| 5.2F | 1.3% AA, | Swiffer WetJet Pad | 65 | 5 | 36 | 3 |
| 5.2J | 8.7% | Clorox Cleaning Wipe | 149 | 4 | 83 | 2 |
| | MAPTAC | | | | | |
| 5.3B | 90% AAM, | Bounty Paper Towel | 121 | 6 | 68 | 3 |
| 5.3F | 2.5% AA, | Swiffer WetJet Pad | 74 | 2 | 41 | 1 |
| 5.3J | 7.5% | Clorox Cleaning Wipe | 151 | 7 | 84 | 4 |
| | MAPTAC | | | | | |
| 5.4B | 90% AAM, 5% | Bounty Paper Towel | 105 | 6 | 59 | 3 |
| 5.4F | AA, 5% | Swiffer WetJet Pad | 95 | 7 | 53 | 4 |
| 5.4J | MAPTAC | Clorox Cleaning Wipe | 138 | 7 | 77 | 4 |
| 5.5B | 90% AAM, | Bounty Paper Towel | 98 | 4 | 55 | 2 |
| 5.5F | 7.5% AA, | Swiffer WetJet Pad | 67 | 5 | 37 | 3 |
| 5.5J | 2.5% | Clorox Cleaning Wipe | 133 | 2 | 75 | 1 |
| | MAPTAC | | | | | |
| 5.6B | 90% AAM, | Bounty Paper Towel | 93 | 2 | 52 | 1 |
| 5.6F | 10% AA | Swiffer WetJet Pad | 54 | 8 | 30 | 4 |
| 5.6J | | Clorox Cleaning Wipe | 135 | 3 | 76 | 2 |

*Mirapol ® HSC 300 was obtained from Rhodia S. A. (Paris France).

### Test Methods

### Determination of Percent Solids

An empty weigh pan (VWR disposable aluminum crinkle dishes with tabs, VWR Catalog #25433-010; or equivalent pan) is weighed to within ±0.1 mg (Weightₚₐₙ). An aliquot of a polymer solution, for example a polymer solution as prepared above, 2.5±0.5 grams, is placed into the pan and weighed to within ±0.1 mg (Weight_{Pan+Polymer Solution}). The pan and the polymer solution are placed in an 80° C. ventilated oven, uncovered for 12 hours. After cooling to room temperature, the pan and the polymer solids are then weighed to within ±0.1 mg (Weight_{Pan+Polymer Solid}). The percent solids is calculated as follows:

$$PercentSolids ( \% ) = ( \frac{{Weight}_{Pan + PolymerSolid} - {Weight}_{Pan}}{{Weight}_{Pan + PolymerSolution} - {Weight}_{Pan}} ) * 100 \%$$

### Preparation of 0.02% Polymer Solution

Using the amounts listed in Table 2, the polymer solutions prepared above need to be diluted to 0.02% percent solids with deionized water or for any other polymer solution to be tested that is greater than 0.02% percent solids, it needs to be diluted with deionized water to 0.02% percent solids using the following equation:

$$\frac{{Weight}_{PolymerSolution}}{{Weight}_{PolymerSolution + Water}} = \frac{0.02 \%}{PercentSolids ( \% )}$$

If the polymer solution is less than 0.02% percent solids, then no dilution is necessary.

A receiving vessel large enough to hold the diluted solution is tared. The desired amount of the original polymer solution is added to the receiving vessel and the weight (of the solution only) recorded to within ±1 mg (Weight_{Polymer Solution}). The polymer solution is then diluted to 0.02% with deionized water and the weight recorded to within ±0.01 g (Weight_{Polymer Solution+water}). The diluted solutions are capped and allowed to sit for 24 hours with occasional agitation prior to use to ensure polymer dissolution. The concentration is calculated as follows:

$$Concentration ( \% ) = \frac{{Weight}_{PolymerSolution} * PercentSolids ( \% )}{{Weight}_{PolymerSolution + Water}}$$

### Polymer Molecular Weight Determination

Polymer molecular mass is determined by GPC SEC/MALS. The HPLC is a Waters Alliance 2695 HPLC with an auto injector equipped with a bank of two linear μStyragel HT columns at room temperature. The flow rate is 1.0 mL/min and the mobile phase is dimethyl sulfoxide (DMSO) with 0.1% (weight/volume) LiBr. The detectors are Wyatt Dawn EOS Light scattering detector calibrated with toluene and normalized using 25K dextran in mobile phase and a Wyatt Optilab rEX refractive index detector at 30° C.

Samples for analysis are prepared at a known concentration in the range of 1 to 5 mg/mL. Samples are filtered using 0.2 μm polypropylene membrane filters. The injection volume is 100 μL. The data are collected and analyzed using ASTRA 5.3.4.14. Values for dn/dc are calculated from the RI trace assuming 100% mass recovery. Number average molecular weight and polydispersity index are calculated and reported.

### Preparation of Treated Article

Rectilinear 3.00 inch×4.00 inch pieces of commercial products (see below for description) are obtained using a 3 inch×4 inch die cutter resulting in samples having a basis weight of from 19 gsm to 33 gsm for handsheets, less than or equal to 100 gsm for paper towels, paper napkins, wipes, sponges, for the floorsheet removed from mops, and for the cleaning (surface contacting) substrate and/or non-surface contacting substrate of other multilayered cleaning systems, and less than or equal to 150 gsm for predominately cotton samples such as cheesecloth, cotton pads, and clothing (samples outside this range are discarded). For paper towels, at least the first and last 5 towels are discarded since they might be contaminated with glue commonly used to fasten the paper towels. The paper towel specimens are cut so that the perforations between towels run perpendicular to the 4 inch width cut. The paper towel specimens are cut so that they are free of perforations. The napkin specimens are cut without first unfolding the napkins, thereby maintaining the original ply of the sample. For mops and other multilayered cleaning systems, the substrate that contacts the floor or the surface to be cleaned is removed and used as the test specimen. In the case where this substrate is hydrophobic, the next adjacent layer(s) (of varying gsm) can also be used in combination with the floor substrate. The Swiffer WetJet Pad Refills are cut open along the outer edges. The topsheet substrate and adjacent core layer are discarded, and the floor sheet substrate and adjacent core layer are used. The Clorox Ready Mop Absorbent Mopping Pads are also cut open along the outer edges. All other layers except for the floor sheet substrate are discarded. Any specimen that is pre-moistened is first air dried prior to cutting except for sponges. For sponges, the sponge is dampened slightly and sliced using a Berker Deli Slicer (model 823 E, South Bend, Ind.) set at the 2.5 thickness setting prior to die cutting to a 3 inch×4 inch rectangle (resulting in a weight of 0.58 g±0.15 g after conditioning at a temperature of 70° F.±2° F. and a relative humidity of 50%±2% for at least 2 hours, preferably overnight). All specimens are obtained from a portion of the test material at least 0.5 inches from any edges.

The specimens noted above are labeled with the specimen name using a ball-point pen or equivalent marker. The specimens are conditioned at a temperature of 70° F.±2° F. and a relative humidity of 50%±2% for at least 2 hours, preferably overnight. After conditioning the specimens are each weighed to within ±10 mg (Weight_{substrate}) while still maintaining the conditioning conditions. The remainder of the work is done in a laboratory at a temperature of 73° F.±3.5° F. and a relative humidity <70%. The specimen is placed on a lattice (23.75 inch×47.75 inch polystyrene light panel manufactured by Plaskolite, Inc., Columbus, Ohio, available from Home Depot as model #1425005A; or equivalent lattice).

If a specimen has been pre-treated, it can be tested without further addition of any polymer solution or water. Thus, the specimen is simply cut to a 3 inch×4 inch piece.

If a specimen has not been pre-treated with a polymer solution, the specimen is treated with a total of 3.8 mL (in 1-4 aliquots to avoid oversaturation if necessary) of the 0.02% percent solids polymer solution prepared as described above or if the polymer solution being tested is less than 0.02% percent solids, then the total amount of the polymer solution to be added to each specimen (in 1-4 aliquots to avoid oversaturation if necessary) is determined by the following equation:

$$AmountAdded ( mL ) = \frac{3.8 mL * 0.02 \%}{PercentSolids ( \% )}$$

The polymer solution is then applied to the upper (treated) side of the specimen only. In between aliquots, time (at least 1.5 hours) is given to allow the specimen to partially dry. After application of all the polymer solution, the specimens are left to air dry for at least 4 hours, typically overnight on the lattice.

When evaluating the Soil Adsorption Value exhibited by only the polymer, then a handsheet is used as the substrate.

A. Scott Paper Towels Mega Roll Choose-a-Size, produced by Kimberly-Clark, Neenah, Wis. (6 rolls, 102 paper towels per roll, 1 ply, 11.0 inch×7.3 inch, available at Walmart).

B. Bounty Paper Towel White, produced by Procter & Gamble, Cincinnati, Ohio (1 roll, 52 sheets per roll, 2-ply, 11 inch×11 inch, available at Walmart).

C. Kleenex Viva Paper Towel White Big Roll, produced by Kimberly-Clark, Neenah Wis. (1 roll, 59 sheets, 1-ply, 11 inch×10.4 inch, available at Walmart).

D. Bounty Quilted Napkins White, produced by Procter & Gamble, Cincinnati, Ohio (1 pack, 220 napkins, 1-ply, 12.1 inch×12 inch, available at Walmart).

E. Swiffer Sweeper Wet Mopping Refills, produced by Procter & Gamble, Cincinnati, Ohio (12 wet mopping cloths, 10 inch×8 inch, available at Walmart).

F. Swiffer WetJet Pad Refills, produced by Procter & Gamble, Cincinnati, Ohio (24 cleaning pads, available at Walmart).

G. Clorox Ready Mop Absorbent Mopping Pads, produced by The Clorox Company, Oakland, Calif. (16 refill pads, 8.5 inch×11.5 inch, available at Walmart).

H. O-Cel-O Sponge, produced by 3M (3 sponges, 5.9 inch×3.0 inch×0.9 inch, available at Walmart).

I. Lysol Disinfecting Wipes Citrus Scent, produced by Reckitt Benckiser (35 wet wipes, 7 inch×8 inch, available at Walmart).

J. Clorox Disinfecting Wipes Lemon Fresh, produced by The Clorox Company, Oakland, Calif. (35 wet wipes, 7 inch×8 inch, available at Walmart).

K. Mr. Clean Wipe Multi-Surface Wipes, produced by Procter & Gamble, Cincinnati, Ohio (62 premoistened wipes, 7 inch×8 inch available at http://www.amazon.com/Mr-Clean-Multi-surface-Disinfecting-62-Count/dp/B000UD09JO).

L. Windex Original Glass & Surface Wipes, produced by SC Johnson & Son, Racine, Wis. (28 pre-moistened wipes, 7 inch×10 inch, available at Walmart).

M. Pampers Sensitive Baby Wipes, produced by Procter & Gamble, Cincinnati, Ohio (1 tub, 64 wipes, 7 inch×7 inch, available at Walmart).

N. Huggies Sensitive Baby Wipes, produced by Kimberly-Clark, Neenah, Wis. (1 tub, 64 wipes, 7.7 inch×6.7 inch, available at Walmart).

O. Clorox Handi Wipes, produced by The Clorox Company, Oakland, Calif. (6 wipes, 21 inch×11 inch, available at Krogers).

P. Shout Color Catcher, produced by SC Johnson & Son, Racine, Wis. (24 sheets, 9.8 inch×4.7 inch, available at Walmart).

Q. VWR CheeseclothWipers, produced by Fisher Scientific (100% cotton, white, package of 200, 4 inch×4 inch, available at VWR #21910-107).

R. VWR Cotton Pad, distributed by VWR International (100% cotton, package of 100, 4 inch×4 inch, available at VWR #21902-985).

S. Mainstays Flour Sack Towels, distributed by Walmart (100% cotton, white, 5 pack, 28 inch×29 inch, available at Walmart).

T. Handsheets—as prepared below.

Preparation of Handsheet—

In order to test the soil adsorption properties of a material, such as a polymer, a handsheet is prepared as follows and is then used in the Soil Adsorption Test Method described above.

A handsheet is a handmade specimen of a fibrous structure. Handsheets are prepared at target basis weight of 26.8 g/m², but no less than 19 g/m² and no more than 33 g/m² using the following procedure.

a. Pulp Preparation—

A pulp slurry of Northern Softwood Kraft (NSK) pulp is made as follows. Using an analytical balance capable of weighing to ±0.0002 g, weigh out 30 g of NSK dry lap (pulp). Record the weight of the NSK dry lap. Record the percent bone-dry pulp or consistency for this pulp. Put 500 mL of 23° C.±2° C. of City of Cincinnati, Ohio Water (or equivalent having the following properties: Total Hardness=155 mg/L as CaCO₃; Calcium content=33.2 mg/L; Magnesium content=17.5 mg/L; Phosphate content=0.0462) into a 2000 mL polypropylene beaker. Add the weighed NSK dry lap to the water in the beaker immediately following the addition of the water to the beaker. After the NSK dry lap is completely wetted (about 50-60 seconds), remove the wetted NSK dry lap and manually tear into small pieces of wetted NSK dry lap, approximately 2 cm² or less pieces. Add the small pieces of wetted NSK dry lap back into the water in the beaker. Let the wetted NSK dry lap soak in the water for at least 1 hour, typically 1-2 hours. At the end of the soaking period, transfer the contents of the beaker (water and pulp) to a disintegrator tank of a pulp disintegrator commercially available from Testing Machines, Inc. under the tradename 73-18 Pulp Disintegrator or its equivalent. Follow the manufacturer's instructions for maintaining, calibrating, and cleaning the disintegrator, as needed. The disintegrator must meet TAPPI Standard T-205. Using more of the City of Cincinnati, Ohio water (or equivalent water as described above) delivered by a polyethylene wash bottle, wash and remove any remaining pulp adhering to the beaker into the disintegrator tank. Additional City of Cincinnati, Ohio water (or equivalent water as described above) is added to the disintegrator tank to result in a total of 1500 mL of total volume in the disintegrator tank.

Next, place the disintegrator tank containing the pulp and City of Cincinnati, Ohio water (or equivalent water as described above) (23° C.±2° C.) on the distintegrator's platform and position it under the shaft and impeller blade of the disintegrator. Clamp the disintegrator tank firmly in place on the disintegrator's platform. Lower the impeller blade into position and lock in place according to the manufacturer's instructions. Put the disintegrator tank's lid in place on the disintegrator tank. Set an interval timer with timed switch outlet for exactly 10 minutes. Turn the disintegrator on and start the timer with the alarm on the timer turned on such that the alarm sounds and the disintegrator turns off automatically after exactly 10 minutes of operation. Turn the alarm off. Use the pulp slurry (pulp plus City of Cincinnati, Ohio water (or equivalent water as described above)) in the disintegrator within an hour after the completion of the 10 minutes of operation. Do not let the pulp slurry stand idle for more than an hour before using it to make the handsheets.

b. Proportioning of Pulp—

After the pulp slurry is prepared in the disintegrator tank as described above, the pulp slurry is then proportioned in a proportioner, such as a Noble and Wood Handsheet Forming Machine or a proportioner and handsheet forming machine, which is commercially available from Adirondack Machine Corporation as follows.

To a proportioner having a 19-21 L stainless steel tank, City of Cincinnati, Ohio water (or equivalent water as described above) is added to fill the tank to about half full (about 9-10 L). The agitator of the proportioner is turned on and the speed of the agitator is adjusted to 23 rpm±2 rpm to provide good mixing once the pulp slurry is added. Good mixing can be determined by seeing that the pulp slurry is evenly mixing with the City of Cincinnati, Ohio water (or equivalent water as described above) that is added to the tank. Next, add the equivalent of 30 g of bone-dry pulp of the pulp slurry produced above to the tank. After addition of the pulp slurry to the tank, set the volume scale of the proportioner to the 19 L mark. Add additional City of Cincinnati, Ohio water (or equivalent water as described above) to make the liquid level approximately even with the top of the hook on the solution indicator pointer of the proportioner.

c. Forming Handsheet—

A handsheet is made from the pulp slurry present in the proportioner, described above, as follows.

The handsheet is made using a 12″×12″ stainless steel sheet mold commercially available from Adirondack Machine Corporation. First, open the drain valve on the deckle box of the sheet mold and completely drain the deckle box. The deckle box needs to be clean and free of contaminants. Close the drain valve and open the deckle box. Turn on the water supply, City of Cincinnati, Ohio water (or equivalent water as described above) and allow the deckle box to overflow. Place a clean forming wire (84M 14″×14″ polyester monofilament plastic cloth, commercially available from Appleton Wire Co.), on the coarse deckle box wire so as not to entrap any air bubbles under the forming wire. If air bubbles persist, eliminate by rubbing the wire gently with hands before closing the deckle box. Air bubbles under the forming wire, if not removed, will cause holes in the handsheet and makes the handsheet unacceptable for use in the tests described herein.

After the forming wire has been thoroughly wetted by the water, close and lock the deckle box and allow the water to rise to 8½″ from the forming wire in the deckle box. A mark on the inside of the deckle box should be used to permanently indicate this volume. Add 2543 mL of the pulp slurry from the proportioner to the water in the deckle box using the proportioner sample container. Using the perforated metal deckle box plunger, distribute the pulp slurry uniformly by moving the plunger from near the top of the pulp slurry to the bottom of the pulp slurry within the deckle box and back for three complete up and down cycles. Do not touch the forming wire on the downward strokes. After the third cycle, bring the plunger up and pause for two seconds holding the plunger plate just beneath the pulp slurry surface (to eliminate wave action) and then withdraw slowly. Make sure that the pulp slurry is undisturbed in the deckle box.

Depress the switch to activate the timed opening of the drop valve of the deckle box. The drop valve will close automatically after the deckle box is completely drained. Most units completely drain in about 20-25 seconds. After the drop valve closes, open the deckle box and carefully remove the forming wire with fiber mat side up from the deckle box. Immediately place the forming wire with fiber mat side up on a vacuum box's surface (a vacuum box table) having a surface at a vacuum slot (13″× 1/16″ 90° flare) over which the forming wire with fiber mat passes. Keep the edge of the forming wire which is next to the operator in the same relative position during this transfer from the deckle box to the vacuum box table.

The vacuum box table's vacuum valves are set such that the low level of vacuum (pre-vacuum) peaks at 4.0±0.5″ Hg and the high level vacuum peaks at 10.0±0.5″ Hg according to an Ashcroft Vacuum Gauge Model 1189, range 0-15″ Hg commercially available from Ashcroft Inc.

Turn on the vacuum pump (a Nash H4 Pump with a draw of 106 cfm Motor-10 HP, 1745 rpm, 3 Ph, 60 Hz available from ECM Inc.) associated with the vacuum box table. Engage the low level vacuum (pre-vacuum). Position the forming wire with the fiber mat side up on the vacuum box table so that the front edge of the forming wire (edge next to the operator) extends over the vacuum slot about ¼″-½″. Pull the forming wire with fiber mat across the vacuum slot in 1±0.3 seconds at a uniform rate. The vacuum gauge should peak at 4.0±0.5″ Hg. This step is referred to as the Pre-vacuum Step.

Next, turn the low level vacuum and open the high level side of the vacuum system. Place the knubby side up of a transfer wire (44M 16″×14″ polyester monofilament plastic cloth commercially available from Appleton Wire Co. with the knobby side, which is the sheet side, marked with an arrow indicating the machine direction) on the vacuum box table behind the vacuum slot. The transfer wire is placed on the vacuum box table such that the 16″ length is perpendicular to the vacuum slot. Carefully turn the forming wire with the fiber mat over keeping the edge of the forming wire, which has been next to the operator, in the same relative position. Gently place the forming wire with fiber mat onto the center of the transfer wire, forming a “sandwich” so that the front edge of the transfer wire (edge next to the operator) extends over the vacuum slot about ¼″-½″. The direction of travel of the fiber mat over the vacuum slot must be identical to the direction of travel of the forming wire with fiber mat during the Pre-vacuum Step described above. The “sandwich” is pulled across the vacuum slot in 1±0.3 seconds at a uniform rate. The vacuum gauge should peak at 10.0±0.5″ Hg. This step, which transfers the fiber mat from the forming wire to the transfer wire, is called the Transfer Vacuum Step.

Close the high level vacuum and turn off the entire vacuum system. By this time the fiber mat has become a handsheet. Next, place the “sandwich” on the vacuum box table. Separate the forming wire from the handsheet and the transfer wire by gently lifting one corner of the forming wire and removing it, leaving the handsheet attached to the transfer wire. Keep the edge of the fabric next to the operator in the same relative position as the handsheet as it was during the Transfer Vacuum Step. Make an arrow with an indelible pencil (a water color pencil commercially available from Dick Blick Art Supplies) on a corner of the handsheet to indicate the direction of travel across the vacuum slot. This identifies the handsheet's machine direction.

Next, pass the transfer wire with the handsheet attached through an E-100 Drum Dryer commercially available from Adirondack Machine Corporation with the transfer wire next to the drum dryer and with the edge that was kept next to the operator going into the drum dryer last. Pass the transfer wire with the handsheet attached through the drum dryer a second time with the handsheet next to the drum dryer.

The handsheet is removed immediately after exiting the dryer drum the second time while it is still warm.

The handsheet formed must be at a target basis weight of 26.8 g/m², but no less than 19 g/m² and no more than 33 g/m² suitable for testing. If the basis weight is less than 19 g/m² or greater than 33 g/m² then either the amount of pulp is too small or too large and the process needs to be adjusted accordingly to produce a handsheet with a target basis weight of 26.8 g/m², but no less than 19 g/m² and no more than 33 g/m².

### Soil Solution Preparation

A centrifuge tube (VWR brand 50 mL superclear ultra high performance freestanding centrifuge tube with flat caps, VWR Catalog #82018-052; or equivalent tube) is labeled with the specimen name and weighed to within ±1 mg (Weight_{Vial+Cap}). Next 0.1784 g±0.0005 g of a model soil (Black Todd Clay available from Empirical Manufacturing Co., 7616 Reinhold Drive, Cincinnati, Ohio 45237-3208) is weighed (Weight_{Added Soil}) and then placed into the centrifuge tube. Deionized water, 25.0 mL±0.2 mL, is added slowly to the centrifuge tube using a suitable dispenser. The deionized water is poured carefully into the centrifuge tube to avoid causing a plume of dust from the model soil. If a plume of dust occurs, the tube is discarded and a new tube is prepared. The tube is then re-weighed to within ±1 mg (Weight_{Vial+Cap+Dispersion}).

A Petri dish (VWR sterile Petri dish, Simport plastics, 60 mm×15 mm, 28 mL volume, VWR Catalog #60872-306; or equivalent) is labeled with the specimen name and weighed to within ±1 mg (Weight_{Dish}).

### Soil Adsorption Test Method

The 3 inch×4 inch specimen is folded in half with the treated side facing in so that it is 1.5 inch long ×4 inch wide. An accordion style (paper fan) folding technique is then used to fold the specimen 5 times to produce a sample that contains 6 segments each about ⅔ of an inch in width. The capped centrifuge tube containing the model soil and water is agitated/shaken to disperse the soil in the water to form a soil dispersion. The centrifuge tube is then uncapped permitting the folded specimen to be fully immersed into the dispersion of model soil and water in the centrifuge tube so that the folds run parallel to the length of the centrifuge tube. The tube is immediately re-capped and shaken in a WS 180 degree shaker for 60±1 seconds. The WS 180 degree shaker (Glas-Col #099AWS18012; or equivalent shaker) is set (50% speed) so that it inverts the specimen 160-170 degrees every 1 second.

After shaking, the folded specimen is carefully removed over the Petri dish using laboratory tweezers. Care must be taken to ensure that all of the dispersion is kept either in the original centrifuge tube or corresponding Petri dish. The dispersion is wrung from the specimen using a “wringing” motion and collected in the Petri dish (≧85% of the dirt dispersion should be collected if the specimen is a paper towel, paper napkin, wipe, floor substrate of a mop, the cleaning (surface contacting) substrate of other multilayered cleaning systems, or clothing, ≧60% of the dirt dispersion should be collected if the specimen contains an absorbent pad such as the a mop containing an absorbent layer like the Swiffer Wet Jet Pad, sponge, or cotton pads). Once the dispersion has been removed from the specimen, the specimen is discarded. The remaining dispersion is poured from the centrifuge tube into the Petri dish after swirling the mixture to re-disperse the model soil into the water, thereby ensuring that no model soil is inadvertently left behind in the centrifuge tube. The Petri dish containing the model soil/water mixture is weighed to within ±1 mg (Weight_{Dish+Effluent}). The Petri dish is then placed into a vented laboratory drying oven at 60° C. until the sample is dry, preferably overnight.

Once the specimen is dry, it is removed from the oven and allowed to cool to room temperature (73° F.±3.5° F.). The Petri dish containing the dried model soil is re-weighed to within ±1 mg (Weight_{Dish+DriedSoil}).

### Calculations

To calculate the amount of residual model soil (Mass_{Residual Soil}) left in the Petri dish, the following equation is used:

Mass_{ResidualSoil}=Weight_{Dish+DriedSoil}−Weight_{Dish}

Residual model soil is reported in mg.

To calculate the amount of soil adsorbed (Soil Retained) in the specimen, the following calculation is used:

Soil Retained=Weight_{AddedSoil}−Mass_{ResidualSoil}

The amount of soil adsorbed is reported in mg.

To calculate the percent of soil retained (% Soil Retained), the following calculation is used:

$$\% SoilRetained = [ \frac{SoilRetained}{{Weight}_{AddedSoil}} ] * 100 \%$$

The test is performed on four replicates and the average amount of soil adsorbed (also known as the Soil Adsorption Value) and the average percent of soil retained (% Soil Retained_{avg}) are calculated for the article.

### Charge Density Test Method

The charge density of a polymer, such as a soil adsorption polymer, can be determined by using a Mutek PCD-04 Particle Charge Detector available from BTG, or equivalent instrument. The following guidelines provided by BTG are used.

Start with a 0.1% solution (0.1 g polymer+99.9 g deionized water) (sample). Depending on the titrant consumption increase or decrease polymer content if needed. Solution pH is adjusted prior to final dilution as charge density of many polymers and/or additives is dependent upon solution pH. A pH of 4.5 is used here.

1. Place 20 mL of sample in the PCD measuring cell and insert piston.

2. Put the measuring cell with piston and sample in the PCD, the electrodes are facing the rear. Slide the cell along the guide until it touches the rear.

3. Pull piston upwards and turn it counter-clock-wise to lock the piston in place.

4. Switch on the motor. The streaming potential is shown on the touch panel. Wait 2 minutes until the signal is stable.

5. Use an oppositely charged titrant (for example for a cationic sample having a positive streaming potential: use an anionic titrant). Titrants are available from BTG consisting of 0.001N PVSK or 0.001N PolyDADMAC.

6. An automatic titrator available from BTG is utilized. After selecting the proper titrant, set the titrator to rinse the tubing by dispensing 10 mL insuring that all air bubbles have been purged.

7. Place tubing tip below the surface of the sample and start titration. The automatic titrator is set to stop automatically when the potential reaches 0 mV.

8. Record consumption of titrant, ideally, the consumption of titrant should be 0.2 mL to 10 mL; otherwise decrease or increase polymer content.

9. Repeat titration of a second 20 mL aliquot of the polymer sample.

10. Calculate charge demand (solution) or charge demand (solids);

$$Charge demand ( eq \text{/} L ) = \frac{V titrant used ( L ) \times Conc . of titrant in Normality ( eq \text{/} L )}{Volume of sample titrated ( L )}$$

$$Charge demand ( eq \text{/} g ) = \frac{V titrant used ( L ) \times Conc . of titrant in Normality ( eq \text{/} L )}{W t . solids of the sample or its active substance ( g )}$$

The charge demand (charge density) of a polymer is reported in meq/g units.

### Basis Weight Test Method

The rectilinear 3.00 inch×4.00 inch piece of specimen cut as above in the soil adsorption test method is conditioned in a conditioned room at 70° F.±2° F. and a relative humidity of 50%±2% for at least 2 hours, typically overnight. The specimen is weighed to within ±10 mg (Weight_{Substrate}) while still maintaining the conditioning conditions. The Basis Weight of the specimen is then calculated as follows:

$$BasisWeight ( gsm ) = ( \frac{{Weight}_{Substrate} ( g )}{3 inch \times 4 inch} ) * {( \frac{inch}{2.54 cm} )}^{2} * {( \frac{100 cm}{m} )}^{2}$$

### Moisture Content Test Method

The moisture content present in an article is measured using the following Moisture Content Test Method.

An article or portion thereof (“sample”) is placed in a conditioned room at a temperature of 73° F.±4° F. (about 23° C.±2.2° C.) and a relative humidity of 50%±10% for at least 24 hours prior to testing. The weight of the sample is recorded when no further weight change is detected for at least a 5 minute period. Record this weight as the “equilibrium weight” of the sample. Next, place the sample in a drying oven for 24 hours at 70° C. with a relative humidity of about 4% to dry the sample. After the 24 hours of drying, remove the sample from the drying oven and immediately weigh the sample. Record this weight as the “dry weight” of the sample. The moisture content of the sample is calculated as follows:

$$\% Moisture in sample = 100 \% \times \frac{( Equilibrium weight of sample - Dry weight of sample )}{Dry weight of sample}$$

The % Moisture in sample for 3 replicates is averaged to give the reported % Moisture in sample.

### III. Articles

The present disclosure further relates to cleansing articles for cleaning surfaces (e.g., hard surfaces). Such articles can include a dry material, for example a dry fibrous structure such as a dry paper towel, mop, sponge; or a pre-moistened, liquid composition-containing towel or wipe or pad, that exhibit improved Soil Adsorption Values as measured according to the Soil Adsorption Test Method described herein compared to known articles using a soil capture agent described herein. It will be appreciated that the article can include the entire article or a portion of the article for which a soil capture agent and/or cleaning composition is applied or contacted with. In certain embodiments, a portion of the article can include a particular layer or section of an article, including, for example, the portion of an article tested via the Soil Adsorption Test Method described herein.

In certain embodiments, at least a portion of an article may exhibit a Soil Adsorption Value of at least 75 mg; in certain embodiments about 85 mg or more; in certain embodiments about 100 mg or more; in certain embodiments about 120 mg or more; and in certain embodiments about 140 mg or more as measured according to the Soil Adsorption Test Method described herein.

In one example, the article comprises a web. A web can include one or more of a nonwoven web and a woven web, or a combination thereof. In certain embodiments, a web can include a plurality of pulp fibers. In certain embodiments, a web can include a fibrous structure.

Non-limiting examples of processes for making fibrous structures include known wet-laid processes, such as wet-laid papermaking processes, and air-laid processes, such as air-laid papermaking processes. Wet-laid and/or air-laid papermaking processes and/or air-laid papermaking processes typically include a step of preparing a composition comprising a plurality of fibers that are suspended in a medium, either wet, more specifically aqueous medium, or dry, more specifically gaseous medium, such as air. The aqueous medium used for wet-laid processes is oftentimes referred to as a fiber slurry. The fiber composition is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

Another process that can be used to produce the fibrous structures is a melt-blowing and/or spunbonding process where a polymer composition is spun into filaments and collected on a belt to produce a fibrous structure. In one example, a plurality of fibers may be mixed with the filaments prior to collecting on the belt and/or a plurality of fibers may be deposited on another fibrous structure comprising filaments.

The fibrous structures may be homogeneous or may be layers in the direction normal to the machine direction. If layered, the fibrous structures may comprise at least two and/or at least three and/or at least four and/or at least five layers.

Fibers are typically considered discontinuous in nature. Non-limiting examples of fibers include wood pulp fibers and synthetic staple fibers such as polyester fibers.

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

Papermaking fibers useful in the present disclosure can include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

In certain embodiments, a sanitary tissue product can include a fibrous structure. Sanitary tissue products (as well as other cleansing articles or portions thereof) may exhibit a basis weight between about 10 gsm to about 120 gsm and/or from about 15 gsm to about 110 gsm and/or from about 20 gsm to about 100 gsm and/or from about 30 to 95 gsm. It will be appreciated that suitable cleansing articles as described herein can have a basis weight of about 150 gsm or less; in certain embodiments a basis weight of about 100 gsm or less; and in certain embodiments a basis weight from about 30 gsm to about 95 gsm based on the Soil Adsorption Test Method described herein (e.g., the basis weight is measured relative to the sample size). It will be appreciated that certain articles such as cotton pads, clothing, cheesecloth will have higher basis weights based on the Soil Adsorption Test Method then paper towels, paper napkins, wipes, sponges, or floor sheets removed from a mop.

The fibrous structure of the present invention may comprise a plurality of pulp fibers. Further, the fibrous structure of the present invention may comprise a single-ply or multi-ply sanitary tissue product, such as a paper towel.

In another embodiment, the material of the present invention may comprise a web, for example a fibrous structure, in the form of a cleaning pad suitable for use with a cleaning device, such as a floor cleaning device, for example a Swifter® cleaning pad.

The fibrous structures in certain embodiments may be co-formed fibrous structures. Such suitable examples of co-form fibrous structures are described in U.S. Pat. No. 4,100,324.

In still another embodiment, an article may comprise a foam structure or a sponge. Suitable foam structures or sponges are described in U.S. Pat. Nos. 4,638,017, 4,738,992, and 4,957,810; and U.S. Patent Application Publication Nos. 2007/0061991 A1, 2007/0161533 A1, and 2009/0163598 A1.

As described herein, the cleansing article can have the soil capture agent applied to the article prior to use or applied to the surface prior to using the article. For example, the soil capture agent can be pre-applied (e.g., embedded) onto a surface of the article prior to using it to clean a surface of an object. In alternative embodiments, a soil capture agent may be applied to a surface to be cleaned (e.g., table top) and then the article is placed into contact with the surface to remove the soil.

In certain embodiments, a soil capture agent may be present in and/or on at least a portion of a cleansing article at a level of greater than 0.005% and/or greater than 0.01% and/or greater than 0.05% and/or greater than 0.1% and/or greater than 0.15% and/or greater than 0.2% and/or less than 5% and/or less than 3% and/or less than 2% and/or less than 1% by weight of the article. In one example, the soil capture agent is present in and/or on the article at a level of from about 0.005% to about 1% by weight of the article.

In certain embodiments, a cleaning system including both an article (or a portion of an article) and the soil capture agent can include from about 0.00001 weight fraction to about 0.001 weight fraction of the soil capture agent. In another embodiment, the cleaning system can include from about 0.0005 weight fraction to about 0.003 weight fraction of the soil capture agent.

In another example, the soil capture agent may be present in and/or on a cleansing article in a pattern, such as a non-random repeating pattern and/or present in and/or on regions of different density, different basis weight, different elevation and/or different texture of the material.

A cleansing article may comprise other ingredients in addition to the soil capture agent, for example a surfactant. Additional surfactants may be desired herein as they further contribute to the cleaning performance and/or shine benefit of the compositions of the present invention. Surfactants to be used herein include anionic surfactants, cationic surfactants, amphoteric surfactants, zwitterionic surfactants, and mixtures thereof. Such surfactants may be present in the material at a level of from about 0.01% to about 0.5% by weight of the article (or a portion of the article). Examples of such suitable surfactants are described in U.S. Patent Application Publication No. 2010/0154823A1 and PCT Application No. PCT/US2011/042644.

Other suitable additives can also be included with the soil capture agent. For example, additives such as perfumes, bleaching agents, brighteners, fabric hueing agents, chelating agents and other active ingredients can be included with the soil capture agent. Suitable examples of such additives are described in PCT Application No. PCT/US2011/042644.

In one example of the present invention, a kit comprising a nonwoven substrate, which may comprise a soil capture agent, such as a cleaning composition which is present on and/or in the nonwoven substrate, and/or a nonwoven substrate and a separate, discrete cleaning composition that may be applied to surfaces and/or to the nonwoven substrate prior to use by a consumer.

Kits comprising Nonwoven Substrate and Compositions

In one embodiment, the present invention also pertains to a kit comprising a nonwoven substrate and a cleaning composition comprising soil capture agent. The cleaning composition may be an aqueous cleaning composition and also may comprise other ingredients selected from surfactants, surface stickiness mitigators, and mixtures thereof. Surface stickiness mitigators are materials that control the adherent character of the soil capture agent. The cleaning composition can be pre-loaded onto the nonwoven substrate to form a premoistened wipe or pad. Alternatively the kit can comprise separate dry substrate, with or without a soil capture agent, and an aqueous composition, with or without a soil capture agent, so long as at least one of them comprises a soil capture agent. In the latter execution, the user can apply, for example via spraying, the cleaning composition to a surface to be cleaned and then use the nonwoven substrate to scrub and absorb the cleaning composition and agglomerated soil. Alternatively the composition can be applied directly to the substrate by the user. There are several advantages of using the soil capture agent in conjunction with a disposable (premoistened or dry) pad/wipe. First, the disposable pad/wipe acts as an anchor for the copolymer, especially if the wipe/pad comprises at least some cellulosic content. While not wishing to be limited by theory, it is believed that ionic interactions (binding of copolymer cationic moieties to negatively charged cellulosic areas of pad/wipe), molecular weight effects (a high molecular weight polymer will anchor better than a low molecular weight polymer) or a combination of ionic and molecular weight interactions cause soil capture agent to strongly adhere onto the nonwoven substrate. This limits transfer of the copolymer to the surface to be treated, reducing the need for, or level of, surface stickiness mitigator. The nonwoven substrate also acts as a repository for agglomerated soil, limiting redeposition of soil onto the treated surface. By limiting soil redeposition, the disposable pad and anchored agglomerating copolymer provide improved cleaning of the treated surface. Finally, agglomerated soil bound to soil capture agent will blacken (dirty) the cleaning wipe/pad, providing consumers with proof that the product is working and a visual cue as to when to change the used pad. This latter effect from soil capture agent is only beneficial if the pad/wipe is intended to be thrown away following limited use (i.e., it is disposable). Darkening of the substrate by agglomeration of particulate soil provides for compelling advertising demonstrations.

### Premoistened Wipe and Pad Compositions:

Premoistened wipes and pads of the invention (defined as premoistened wipe laminates for the purpose of this invention) comprise a cleaning composition comprising a soil capture agent. In one example, the premoistened wipe composition additionally comprises a surface stickiness mitigator. Premoistened wipes are ubiquitous in European household cleaners industry and are used for treating hard surfaces, including but not limited to, kitchen countertops and appliances, bathroom sinks, home windows and mirrors, window blinds, exteriors of toilet bowls, living room tables, home floor cleaning including particulate and hair pick-up, car interior and exterior surfaces, eyeglasses, and hard surfaces that require cleaning in industry, for example machinery. Premoistened wipes can be used by hand for cleaning tasks, or can be attached to or inserted into a handle that limits consumer exposure to the aqueous composition and help provide improved reach. Wipes comprising dry tow fibers are already used in the industry for dusting purposes, for example Swiffer Duster®. Compositions of the present invention include damp/wet dusting compositions optionally comprising tow fibers and preferably comprising some level of hydrophilic fibers. The damp/wet dusting compositions are optionally though preferably used with a handle. The handle can have any length, for example from 15 cm to 1 meter and can be made of any material. Premoistened wipes comprising the agglomerating copolymer of the invention can also be used to remove soils, especially particulate soils that are typically removed by dry dusting sheets and dusters. The compositions can also be used for removal of particulate soils from upholstery and other fabrics including carpet.

The chemical composition of the nonwoven substrate used in this invention can vary from 100% synthetic to 100% non-synthetic fibers. Preferably, the chemical composition of the substrate comprises a blend of synthetic and non-synthetic fibers. More preferably, the synthetic material herein comprises polypropylene, nylon or polyester or blends thereof. Non-synthetic substrates used herein are treated or untreated cellulose fibers that hydrophilic and typically comprise anionic sites. Examples of such fibers include wood pulp, Rayon® and Lyocell®. The composition of the substrate preferably comprises at least 10%, more preferably at least 15%, more preferably at least 20% non-synthetic fibers. Incorporation of cellulosic fibers in the nonwoven substrate advantageously provides an anchor for the agglomerating polymers of the invention via anionic-cationic ionic bonding; this is beneficial because it mitigates the possibility for release of the agglomerating copolymer onto the hard surface to be treated, thereby simultaneously reducing slipperiness and stickiness issues and residue formation.

The distribution of synthetic and non-synthetic fibers within the substrate web can be homogeneous or non-homogeneous. When the distribution of fibers is non-homogeneous, it is preferred that the areas exposed to the hard surface to be treated comprise a higher amount of synthetic fiber than is present in the overall substrate composition. Such a structure keeps a reservoir of fluid within the more absorbent non-synthetic structure, and sandwiched between two areas of the wipe that are more hydrophobic; this results in more controlled release of the aqueous composition and better overall mileage for the wipe. Alternatively, the distribution of fibers can advantageously be made so that only one face of the substrate has more hydrophobic fibers than that of the overall composition. In this case, the substrate would be sided, providing a low friction surface with increased synthetic content, and a second, more draggy surface made of cellulose or treated cellulose derivatives. The presence of increased hydrophobic material at the surface(s) of the substrate also is known to improve the lubricity or glide of the substrate as it is wiped across a variety of hard surfaces. This can provide reassurance of “easier cleaning” for consumers.

According to the present invention, the substrate can be produced by any method known in the art. For example non-woven material substrates can be formed by dry forming techniques such as air-laying or wet-laying such as on a papermaking machine. Other non-woven manufacturing techniques such as hydroentangling, melt blown, spun bonded, needle punched and methods can also be used.

In one example, the nonwoven substrate exhibits a basis weight of from about 20 gsm to about 200 gsm and/or at least 20 gsm and/or less than 150 gsm and/or from about 20 gsm to 110 gsm and/or from about 20 gsm to 80 gsm and/or from about 25 gsm to 60 gsm

The compositions of the invention can be applied to the substrate at any point after it has been dried. For example the composition can be applied to the substrate prior to calendering or after calendering and prior to being wound up onto a parent roll. Typically, the application will be carried out on a substrate unwound from a roll having a width equal to a substantial number of wipes it is intended to produce. The substrate with the composition applied thereto is then subsequently perforated utilizing standard techniques in order to produce the desired perforation line.

In one example, the compositions are applied in an amount of from 1.0 gram (g) to 10.0 gram (g) per gram (g) of dry substrate (i.e., load factor=1× to 10×), preferably from 1.25 g to 8.5 g per g of dry substrate, most preferably from 1.5 g to 7.0 g per g of dry substrate. In one embodiment, a low basis weight monolayer substrate, from 20 gm⁻² to 55 gm⁻², more preferably from 30 gm⁻² to 45 gm⁻², is impregnated with an aqueous composition comprising soil capture agent at load factor of from 1.0 g to 2.5 g per g of dry substrate; in such a scenario, cleaning is achieved via damp dusting of surfaces. A commercially available example of this type composition and application is Swiffer Shine® sold in Europe.

In another example, a kit comprising a dry article, such as dry cleaning pad and separate cleaning composition comprising a soil capture agent is provided. The dry cleaning pad can be a dry duster (with or without optional handle), a laminate of nonwoven substrates without superabsorbent polymer or a laminate of substrates comprising superabsorbent polymer. The aqueous chemistry can be housed in any suitable container and can be applied onto the surface to be treated by any means known in the art. For example, application of solution can be achieved via a separate squirt bottle, aerosol can or spray trigger system. Alternatively, the aqueous chemistry container can also be housed in a container directly attached to, or built into the cleaning device (i.e., on the mop head or the handle). The delivery mechanism can be then actuated by the operator, or can be battery-induced or electrical.

The cleaning pad may be absorbent. An example of a commercially available suitable absorbent pad is the pad in the kit sold under the tradename Clorox Ready Mop®. In a preferred embodiment, the absorbent pad additionally comprises superabsorbent material. Superabsorbent materials are especially beneficial with the compositions of the present invention because they help keep the floor side of the pad free of aqueous cleaning composition, reducing the amount of soil-agglomerating polymer I left behind after mopping. This simultaneously mitigates surface stickiness and keeps the floor substantially residue-free.

The cleaning pads may have an absorbent capacity, when measured under a confining pressure of 0.09 psi (psi=pounds per square inch) after 20 minutes (1200 seconds) (hereafter referred to as “t₁₂₀₀ absorbent capacity”), of at least about 10 g deionized water per g of the cleaning pad. The absorbent capacity of the pad is measured at 20 minutes (1200 seconds) after exposure to deionized water, as this represents a typical time for the consumer to clean a hard surface such as a floor. The confining pressure represents typical pressures exerted on the pad during the cleaning process. As such, the cleaning pad should be capable of absorbing significant amounts of the cleaning solution within this 1200 second period at 0.09 psi pressure. The cleaning pad may have a t₁₂₀₀ absorbent capacity of at least about 15 g/g, more preferably at least about 20 g/g, still more preferably at least about 25 g/g and most preferably at least about 30 g/g. The cleaning pad may have a t₉₀₀ absorbent capacity of at least about 10 g/g, more preferably a two absorbent capacity of at least about 20 g/g. Values for t₁₂₀₀ and t₉₀₀ absorbent capacity are measured by the performance under pressure (referred to herein as “PUP”) method, which is described in detail in the Test Methods section in U.S. Pat. No. 6,045,622, said application being incorporated herein, in its entirety, by reference. The application contains a more complete disclosure of the pads, instruments, etc. that are of use herein.

In one example, the cleaning pad comprises an absorbent layer comprising a thermally bonded airlaid web of cellulose fibers (Flint River, available from Weyerhaeuser, Wa) and AL Thermal C (thermoplastic available from Danaklon a/s, Varde, Denmark), and a swellable hydrogel-forming superabsorbent polymer. The superabsorbent polymer is preferably incorporated such that a discrete layer is located near the surface of the absorbent layer which is remote from the scrubbing layer. Preferably, a thin layer of, e.g., cellulose fibers (optionally thermally bonded) are positioned above the superabsorbent gelling polymer to enhance containment.

In another example, the cleaning pad comprises a scrubbing layer. The scrubbing layer is the portion of the cleaning pad that contacts the soiled surface during cleaning. As such, materials useful as the scrubbing layer must be sufficiently durable that the layer will retain its integrity during the cleaning process. In addition, when the cleaning pad is used in combination with a solution, the scrubbing layer must be capable of absorbing liquids and soils, and relinquishing those liquids and soils to the absorbent layer. This will ensure that the scrubbing layer will continually be able to remove additional material from the surface being cleaned. Whether the implement is used with a cleaning solution (i.e., in the wet state) or without cleaning solution (i.e., in the dry state), the scrubbing layer will, in addition to removing particulate matter, facilitate other functions, such as polishing, dusting, and buffing the surface being cleaned.

The scrubbing layer can be a mono-layer, or a multi-layer structure one or more of whose layers can be slitted to facilitate the scrubbing of the soiled surface and the uptake of particulate matter. This scrubbing layer, as it passes over the soiled surface, interacts with the soil (and cleaning solution when used), loosening and emulsifying tough soils and permitting them to pass freely into the absorbent layer of the pad. The scrubbing layer preferably contains openings (e.g., slits) that provide an easy avenue for larger particulate soil to move freely in and become entrapped within the absorbent layer of the pad. Low density structures are preferred for use as the scrubbing layer, to facilitate transport of particulate matter to the pad's absorbent layer. In order to provide desired integrity, materials particularly suitable for the scrubbing layer include synthetics such as polyolefins (e.g., polyethylene and polypropylene), polyesters, polyamides, synthetic cellulosics (e.g., Rayon®), and blends thereof. Such synthetic materials can be manufactured using known process such as carded, spunbond, meltblown, airlaid, needle punched and the like.

Cleaning pads of the present invention optionally have an attachment layer that allows the pad to be connected to an implement's handle or the support head in preferred implements. The attachment layer will be necessary in those embodiments where the absorbent layer is not suitable for attaching the pad to the support head of the handle. The attachment layer can also function as a means to prevent fluid flow through the top surface (i.e., the handle-contacting surface) of the cleaning pad, and can further provide enhanced integrity of the pad. As with the scrubbing and absorbent layers, the attachment layer can consist of a mono-layer or a multi-layer structure, so long as it meets the above requirements. The attachment layer can comprise a surface which is capable of being mechanically attached to the handle's support head by use of known hook and loop technology. In such an embodiment, the attachment layer will comprise at least one surface which is mechanically attachable to hooks that are permanently affixed to the bottom surface of the handle's support head.

The present invention also includes processes for cleaning a surface, preferably a hard surface, comprising the step of contacting, preferably wiping, said surface using an aqueous composition comprising soil capture agent and preferably a surface stickiness mitigator. For floor cleaning, the compositions can be used in conjunction with conventional mop/cloth and bucket type cleaning systems. These include sponge, string and strip mops. Alternatively, the floor cleaning process can be accomplished using a disposable premoistened wipe or pad comprising an aqueous composition comprising soil capture agent. Examples of such systems include Pledge Wet® and Swifer Wet®. In yet another embodiment, the cleaning process is accomplished using a kit comprising a cleaning implement, dry cleaning pads that are fitted to the cleaning implement, and an aqueous composition comprising soil capture agent. Examples of such a system include Clorox Ready Mop® and Swiffer Wet Jet® (for Wet Jet® the disposable dry pads also comprises superabsorbent polymer). The process for cleaning in each case consists of wetting the floor thoroughly with the aqueous composition. A preferred wiping pattern consists of an up-and-down overlapping motion starting in the bottom left hand (or right hand) side of the section to be cleaned, and continuing the wiping pattern across the floor continuing to use up-and-down wiping motions. Wiping is then continued beginning at the top right (or left) side of the section to be cleaned and reversing the direction of the wipe pattern using a side-to-side motion. Another preferred wipe pattern consists of an up-and-down wiping motion, followed by an up-and-down wiping motion in the reverse direction. All preferred wiping patterns above can be conveyed to the consumer via instructions for use listed in the kit or package artwork.

For cleaning of smaller sized hard surfaces, including, but not limited to, tiles, windows, window and door blinds and shades, sinks, showers, car interiors, vanities, wall areas, countertops, appliances and tables, the compositions are preferably used in the form of a ready-to-use spray bottle or aerosol can. Accordingly, the composition comprising the copolymer of the invention is contacted with the surface to be treated and then spread and wiped up by means of a cleaning implement. Examples of cleaning implements in this context include cotton cloths, sponges, paper towels and chamois. Alternatively, the composition comprising soil capture agent can be incorporated into a premoistened wipe or pad. In such a case, the premoistened wipe or pad is wiped on the surface to be cleaned and across the soiled area(s), preferably using side-to-side wiping motions. Removal of the soil is visually evident because of visible soil agglomeration on the wipe.

### The Process of Cleaning a Hard Surface or an Object

The present disclosure further encompasses a process of cleaning a hard surface or an object.

The process can include the steps of: applying a cleaning composition comprising a soil capture agent onto a hard surface or an object; leaving said composition on said hard-surface or said object to act; optionally wiping said hard-surface or object and/or providing mechanical agitation, and then rinsing said hard-surface or said object. In other embodiments, the soil capture agent can be applied to the article prior to being applied to a hard surface or object.

The cleaning systems (e.g., article and the soil capture agent) particularly suitable for treating hard surfaces located in and around the house, such as in bathrooms, toilets, garages, on driveways, basements, gardens, kitchens, etc.

Other suitable applications of an article in combination with the soil capture agent described herein for purposes of capturing soil will be appreciated by those having skill in the art.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

For clarity purposes, the total “% wt” values do not exceed 100% wt.

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article for cleaning a surface, the article comprising a soil capture agent, wherein the soil capture agent comprises a polymer, the polymer comprising two or more monomeric units selected from the group consisting of:
a. nonionic monomeric units;
b. anionic monomeric units;
c. cationic monomeric units; and
d. zwitterionic monomeric units;
wherein the polymer comprises at least one monomeric unit from group a and at least one monomeric unit selected from groups b, c and d, wherein at least a portion of the article exhibits a Soil Adsorption Value of at least 75 mg as measured according to a Soil Adsorption Test Method described herein.

2. The article of claim 1, wherein the nonionic monomeric units comprise a nonionic hydrophilic monomeric unit.

3. The article of claim 2, wherein the nonionic hydrophilic monomeric unit is derived from a nonionic hydrophilic monomer selected from the group consisting of: hydroxyalkyl esters of α,β-ethylenically unsaturated acids, α,β-ethylenically unsaturated amides, α,β-ethylenically unsaturated monoalkyl amides, α,β-ethylenically unsaturated dialkyl amides, α,β-ethylenically unsaturated monomers bearing a water-soluble polyoxyalkylene segment of the poly(ethylene oxide) type, α,β-ethylenically unsaturated monomers which are precursors of hydrophilic units or segments, vinylpyrrolidones, α,β-ethylenically unsaturated monomers of the ureido type, and mixtures thereof.

4. The article of claim 3, wherein the nonionic hydrophilic monomeric unit is derived from acrylamide.

5. The article of claim 1, wherein the nonionic monomeric units comprise a nonionic hydrophobic monomeric unit.

6. The article of claim 1, wherein the cationic monomeric unit is derived from MAPTAC.

7. The article of claim 1, wherein the cationic monomeric unit is derived from DADMAC.

8. The article according to claim 1, wherein the polymer comprises at least 69.9% wt of a monomeric unit from group a.

9. The article of claim 8, wherein the polymer comprises no more than 30.1% wt of a monomeric unit selected from the group consisting of: group b, group c, group d, and mixtures thereof.

10. The article of claim 1, wherein the polymer comprises at least 69.9% wt of the monomeric unit from group a, no more than 30.1% wt of the monomeric unit from group b and no more than 30.1% wt of the monomeric unit from group c.

11. The article of claim 10, wherein the polymer comprises from about 70% to about 99.5% wt of the monomeric unit from group a, from about 0.1% to about 10% wt of the monomeric unit from group b, and from about 0.3% to about 29% wt of the monomeric unit from group c.

12. The article of claim 10, wherein the polymer comprises from about 70% to about 99.5% wt of the monomeric unit from group a and from about 0.5% to about 30% wt combined of the monomeric unit from group b and the monomeric unit from group c.

13. The article of claim 1, wherein the monomeric unit from group b and the monomeric unit from group c are present in the polymer at a molar ratio of from about 3:1 to about 1:3.

14. The article of claim 1, wherein the polymer exhibits an excess charge of from about 0 to about 0.1 meq/g.

15. The article of claim 1, wherein the polymer exhibits a Polydispersity Index of less than about 2.5.

16. The article of claim 1, wherein the polymer is water-soluble.

17. The article of claim 1 comprising a fibrous structure.

18. The article of claim 17, wherein the fibrous structure comprises a plurality of pulp fibers.

19. The article of claim 17, wherein the fibrous structure comprises a sanitary tissue product.

20. The article of claim 1, further comprising a cleaning composition, wherein the soil capture agent is in the cleaning composition.

21. The article of claim 1, wherein the article is a dry article.

22. A cleaning system comprising at least a portion of an article and a soil capture agent, wherein the soil capture agent comprises a polymer, the polymer comprising three or more monomeric units selected from the group consisting of:
a. nonionic monomeric units;
b. anionic monomeric units;
c. cationic monomeric units; and
d. zwitterionic monomeric units;
wherein the polymer comprises at least one monomeric unit from group a and at least two monomeric units selected from groups b, c and d; and wherein the at least two monomeric units are present in the polymer at a molar ratio of from about 3:1 to about 1:3.

23. The article of claim 22, wherein the polymer comprises at least 69.9% wt of the monomeric unit from group a, no more than 30.1% wt of the monomeric unit from group b and no more than 30.1% wt of the monomeric unit from group c.

24. The cleaning system of claim 22, wherein the soil capture agent is applied to the at least a portion of the article prior to use.

25. The cleaning system of claim 22, wherein the soil capture agent is applied to a surface to be cleaned prior to use.

26. The cleaning system of claim 22 exhibiting a Soil Adsorption Value of at least 75 mg as measured according to a Soil Adsorption Test Method described herein.

27. A cleaning system comprising at least a portion of an article and a soil capture agent, wherein the soil capture agent comprises a polymer, the polymer comprising two or more monomeric units selected from the group consisting of:
a. nonionic monomeric units;
b. anionic monomeric units;
c. cationic monomeric units; and
d. zwitterionic monomeric units;
wherein the polymer comprises at least one monomeric unit from group a and at least one monomeric unit selected from groups b, c and d; and wherein the polymer comprises a number average molecular weight from about 500,000 g/mol to about 2,000,000 g/mol.

28. The cleaning system of claim 27, wherein the soil capture agent is applied to the at least a portion of the article prior to use.

29. The cleaning system of claim 27, wherein the soil capture agent is applied to a surface to be cleaned prior to use.
